(19) United States
(12) Patent Application Publication
(10) Pub. No.: US 2013/0282408 A1
(43) Pub. Date: Oct. 24, 2013

(54) APPARATUS, METHOD AND ARTICLE TO AUTOMATE AND MANAGE COMMUNICATIONS TO MULTIPLE ENTITIES IN A NETWORKED ENVIRONMENT

(71) Applicants: Eric William Snyder, Sammamish, WA (US); Lloyd Sutton Hawes, II, Seattle, WA (US); Hon Seng Long, Redmond, WA (US)

(72) Inventors: Eric William Snyder, Sammamish, WA (US); Lloyd Sutton Hawes, II, Seattle, WA (US); Hon Seng Long, Redmond, WA (US)

(21) Appl. No.: 13/451,168

(22) Filed: Apr. 19, 2012

(51) Int. Cl. G06Q 40/08

(52) U.S. Cl. 705/4

(57) ABSTRACT

Systems and methods automate and manage electronic communications to multiple entities in the insurance industry, particularly between agents/brokers and insurance companies/insurers. Logical relationships are defined, allowing multi-casting of electronic messages and/or documents to appropriate entities (e.g., underwriters of an insurer). Such may be targeted to all or some portion of underwriters with which an agent or broker has an existing relationship. Such may be targeted based on lines of business. Where the message is a request for policy pricing, the correspondence may set out certain details of the policy and may attach one or more electronic documents related to the same request. Correspondence including the same request for policy pricing may automatically be sent out to each of the selected insurers or underwriters by the agent selecting an icon or button.

### BACKGROUND

1. Technical Field

The present disclosure generally relates to networked systems and methods, and in particular to systems and methods for communications between devices operated by agents of an insurance agency and devices operated by employees or contractors of insurance carriers, underwriters or insurers.

2. Description of the Related Art

The insurance industry typically includes a variety of entities which cooperate to provide various types of insurance products or policies. Entities are typically grouped into three principal types, based on their respective roles: 1) insurance carriers or underwriters, 2) insurance agencies or brokerages with their associated agents or brokers, and 3) consumers, policyholders or insureds. Each of these entities may be of various sizes, from individuals to large businesses (e.g., tens or hundreds of thousands of employees).

The insurance carriers or underwriters, commonly referred to as insurers, underwrite the risk or eventuality that is being insured against. The insurers are typically relatively large companies, with deep financial resources. Insurers may be stock companies or alternatively mutual companies (i.e., owned by policyholders). Insurers may be for profit or not for profit companies. Insurers often are classified based on the type of insurance they underwrite. The two fundamental classifications are life insurance companies and non-life, general or property/casualty insurance companies.

Insurance agencies or brokerages initially market insurance to consumers. Insurance agencies or brokerages are typically business entities with one to hundreds or even more agents or brokers. Agencies or agents may in some instances be captive, writing only for one insurer. Alternatively, agencies or brokerages may be independent, writing policies for two more different insurers. Agents or brokers may work directly for the agency or brokerage, as employees, or may work as independent contractors. In some uses, the term agency is used to refer to those entities which owe allegiance to the insurance carrier, underwriter or insurer, while the term brokerage is used to refer to those entities that owe allegiance to the consumer, policyholder or insured.

Agents or brokers typically interact directly with the consumers. Agents or brokers may assist consumers in identifying risks, developing risk management strategies, and selecting amongst various policy options. Policy options may include one or more layers of excess or surplus lines of insurance policies, over and above a primary insurance policy. Agents or brokers may obtain raw data from consumers, complete required forms, and/or solicit one or more insurers to underwrite the policy or policies. The forms are often highly complex, and would be difficult, if not impossible for most consumers to complete.

Each consumer may have very different insurance requirements from those of other consumers. For example, individual or family consumers or insureds may require relatively simple life, health, disability, automobile, homeowners and/or renters insurance policies. Business consumers or insureds may require relatively simple general insurance policies and/or more complicated insurance policies. Thus a large variety of forms are required to cover the insurance needs of the various types of consumers, from individuals, families, small businesses or other organizations, to very large multi-national companies with disparate operations dispersed across multiple regions and/or countries.

Individual insurers may issue policies only in distinct lines of business. For example, property and casualty lines of business may include: fire, allied lines, farm owners multiple, homeowner's multiple, commercial multiple (i.e., general), commercial lines, mortgage guaranty, ocean marine, inland marine, financial guaranty, medical malpractice, earthquake, group accident and health, credit accident and health, other accident and health, workers compensation, other liabilities, product liability, auto liability, auto physical damage, aircraft, fidelity, surety, glass, burglary and theft, boiler and machinery, credit, and international to name a few. Such may be the result of a level of expertise or comfort of the insurer with a particular type of risk. Such may also be the result of limitations placed on the insurer by various regulatory agencies (e.g., insurance commission) and associated laws and rules. Thus, not all insurers are willing or even capable of underwriting all types of risks.

Fulfilling the requirements of any single consumer may require insurance policies underwritten by two or more insurers. Thus, fulfilling the requirements of a single consumer may require an agent or broker to interact with two or more insurers. Fulfilling the requirements of multiple consumers typically requires the agent or broker to interact with two or more insurers.

Agents or brokers typically interact with a subset of all individuals who represent the insurers, referred to herein as underwriters. Such interactions may take a substantial amount of both the agent or broker's workday, as well as that of the underwriter. Automating and managing those interactions may advantageously increase the efficiency of both the agent and the broker, as well as the underwriter, allowing more work to be accomplished in a given amount of time than might otherwise be accomplished. Such may also reduce or eliminate errors, and may result in real saving to the various entities.

### BRIEF SUMMARY

A method of operation in an insurance management system to automate communications between devices operated by a number of agents or brokers of each of a plurality of insurance agencies or brokerages and devices operated by a number of insurers of each of a plurality of insurance carriers, the insurance management system including at least one processor, at least one nontransitory computer-readable medium communicatively coupled to the at least one processor, and a plurality of communications ports to provide communications with the devices operated by the insurers and the agents or brokers, may be summarized as including in response to identification of a plurality of the insurers by a specific one of the agents or brokers, establishing a logical association between the identified plurality of insurers and an electronic message to be electronically sent to the plurality of insurers from the specific one of the agents or brokers regarding one or more existing or potential insurance policies, the logical association being established in the nontransitory computer-readable medium by the at least one processor; receiving, by the insurance management system, an indication of one or more electronic documents to be associated with the message; and in response to the received indication of the one or more electronic documents to be associated with the message, establishing a logical association between the one or more electronic documents and the message, the logical association being established in the nontransitory computer-readable medium by the at least one processor; associating, by the insurance management system, a specific insured with each insurer of the plurality of insurers to which the message is to be sent, the logical association between the specific insured and each insurer of the plurality of insurers to which the message is to be sent being established in the nontransitory computer-readable medium by the at least one processor; and in response to a selection of a user interface element or pressing of a button, automatically sending, by the insurance management system, the message individually to each insurer of the plurality of insurers, the message providing at least one way for each insurer of the plurality of insurers to electronically access the associated one or more electronic documents, and wherein the insurance management system operates without exposing to at least some insurers of the plurality of insurers the identity of any other of the plurality insurers. The insurance management system may operate without exposing to any insurer of the plurality of insurers the identity of any other insurer of the plurality insurers.

The method may further include providing, by the insurance management system, a list of insurers from which the specific one of the agents or brokers may select the plurality of insurers; and receiving, by the insurance management system, the identification of the plurality of the insurers as a result of the selection of the plurality of insurers by the specific one of the agents or brokers.

The method may further include providing, by the insurance management system, a list of one or more representatives of at least one of the plurality of insurers from which the specific one of the agents or brokers may select to individually receive the message; and receiving, by the insurance management system, a selection of at least one of the one or more representatives, wherein the sending the message includes sending the message to the selected at least one of the one or more representatives.

The method may further include receiving, by the insurance management system, an indication of one or more insurance lines of business associated with at least one of the one or more existing or potential insurance policies, and wherein the providing the list of one or more representatives is based on the received indication of the one or more insurance lines of business.

The method may further include receiving, by the insurance management system, an indication of the specific insured, wherein the one or more existing or potential insurance policies is for the specific insured; receiving, by the insurance management system, documents associated with the specific insured; and associating, by the insurance management system, the specific insured with the message, the logical association between the specific insured and the message being established in the nontransitory computer-readable medium by the at least one processor. The receiving, by the insurance management system, an indication of one or more electronic documents to be associated with the message may include receiving an indication of one or more of the received documents associated with the specific insured. The message may include a request for a quote from the plurality of the insurers to underwrite at least one of the one or more existing or potential insurance policies.

The method may further include providing, by the insurance management system, for an agent or broker of the insurance agency or brokerage of the specific one of the agents or brokers, a list of insureds associated with the insurance agency or brokerage including the specific insured; and in response to receiving and indication of selection of the specific insured from the list of insureds by the agent or broker of the insurance agency or brokerage of the specific one of the agents or brokers, providing, by the insurance management system, access to a selectable list of each insurer of the plurality of insurers to which the message was sent.

The method may further include in response to receiving and indication of selection of one of the plurality of insurers from the list of each insurer of the plurality of insurers by the agent or broker of the insurance agency or brokerage of the specific one of the agents or brokers, providing, by the insurance management system: the message sent to the selected one of the plurality of insurers, an indication of the message sent to the selected one of the plurality of insurers being from the specific one of the agents or brokers and a selectable list of the associated one or more electronic documents.

The method may further include in response to receiving the indication of selection of the specific insured from the list of insureds by the agent or broker of the insurance agency or brokerage of the specific one of the agents or brokers, providing, by the insurance management system: for each insurer of the plurality of insurers to which the message was sent, access to a record which indicates one or more of: a name of the insurer, a status of the message sent to the insurer, a status of a request to the insurer included in the message sent to the insurer, a status reason for the status of the message sent to the insurer, a status reason for the request to the insurer included in the message sent to the insurer, a due date of the request to the insurer, an estimated premium associated with the one or more existing or potential insurance policies and an indication of one or more insurance lines of business associated with at least one of the one or more existing or potential insurance policies. The status of the message sent to the insurer, the status of the request to the insurer included in the message sent to the insurer, the status reason for the status of the message sent to the insurer and the status reason for the request to the insurer included in the message sent to the insurer may each be editable by the agent or broker of the insurance agency or brokerage of the specific one of the agents or brokers. The automatically sending the message individually to each insurer of the plurality of insurers may include, for at least one of the insurers of the plurality of insurers, automatically inserting, by the insurance management system, a name of a representative of the at least one insurer in a salutation of the message.

The method may further include providing, by the insurance management system, a message content input interface enabling the specific one of the agents or brokers to create content of the message to be electronically sent to the plurality of insurers; and including, by the insurance management system, content created by the specific one of the agents or brokers via the message content input interface.

An insurance management system to automate communications between devices operated by a number of agents or brokers of each of a plurality of insurance agencies and devices operated by a number of insurers of each of a plurality of insurance carriers may be summarized as including at least one processor; at least one nontransitory computer-readable medium communicatively coupled to the at least one processor, and a plurality of communications ports to provide communications with the devices operated by the insurers and the agents or brokers, wherein: in response to identification of a plurality of the insurers by a specific one of the agents or brokers, the at least one processor establishes in the nontransitory computer-readable medium a logical association between the identified plurality of insurers and an electronic message to be electronically sent to the plurality of insurers from the specific one of the agents or brokers regarding one or more existing or potential insurance policies; the insurance management system receives an indication of one or more electronic documents to be associated with the message; in response to the received indication of the one or more electronic documents to be associated with the message, the at least one processor establishes in the nontransitory computer-readable medium a logical association between the one or more electronic documents and the message; the at least one processor establishes in the nontransitory computer-readable medium a logical association between a specific insured and each insurer of the plurality of insurers to which the message is to be sent; and in response to a selection of a user interface element or pressing of a button, the insurance management system automatically sends the message individually to each insurer of the plurality of insurers, the message providing at least one way for each insurer of the plurality of insurers to electronically access the associated one or more electronic documents, and wherein the insurance management system operates without exposing to at least some insurers of the plurality of insurers the identity of any other of the plurality insurers. The insurance management system may operate without exposing to any insurer of the plurality of insurers the identity of any other insurer of the plurality insurers.

The insurance management system may provide a list of insurers from which the specific one of the agents or brokers may select the plurality of insurers; and receive the identification of the plurality of the insurers as a result of the selection of the plurality of insurers by the specific one of the agents or brokers.

The insurance management system may provide a list of one or more representatives of at least one of the plurality of insurers from which the specific one of the agents or brokers may select to individually receive the message; and receive a selection of at least one of the one or more representatives, wherein the sending the message includes sending the message to the selected at least one of the one or more representatives.

The insurance management system may further include receiving, by the insurance management system, an indication of one or more insurance lines of business associated with at least one of the one or more existing or potential insurance policies, and wherein the providing the list of one or more representatives is based on the received indication of the one or more insurance lines of business.

The insurance management system may receive an indication of the specific insured, wherein the one or more existing or potential insurance policies is for the specific insured; receive documents associated with the specific insured; and associate, in the nontransitory computer-readable medium, the specific insured with the message. The insurance management system may receive an indication of one or more electronic documents to be associated with the message based on an indication received of one or more of the received documents associated with the specific insured.

The insurance management system may customize the message individually for at least some insurers of the plurality of insurers before the insurance management system automatically sends the message.

The insurance management system may provide, for an agent or broker of the insurance agency or brokerage of the specific one of the agents or brokers, a list of insureds associated with the insurance agency or brokerage including the specific insured; and in response to receiving and indication of selection of the specific insured from the list of insureds by the agent or broker of the insurance agency or brokerage of the specific one of the agents or brokers, provide access to a selectable list of each insurer of the plurality of insurers to which the message was sent.

The insurance management system may, in response to receiving and indication of selection of one of the plurality of insurers from the list of each insurer of the plurality of insurers by the agent or broker of the insurance agency or brokerage of the specific one of the agents or brokers, provide: the message sent to the selected one of the plurality of insurers, an indication of the message sent to the selected one of the plurality of insurers being from the specific one of the agents or brokers and a selectable list of the associated one or more electronic documents.

The insurance management system may, in response to receiving the indication of selection of the specific insured from the list of insureds by the agent or broker of the insurance agency or brokerage of the specific one of the agents or brokers, provide: for each insurer of the plurality of insurers to which the message was sent, access to a record which indicates one or more of: a name of the insurer, a status of the message sent to the insurer, a status of a request to the insurer included in the message sent to the insurer, a status reason for the status of the message sent to the insurer, a status reason for the request to the insurer included in the message sent to the insurer, a due date of the request to the insurer, an estimated premium associated with the one or more existing or potential insurance policies and an indication of one or more insurance lines of business associated with at least one of the one or more existing or potential insurance policies.

The status of the message sent to the insurer, the status of the request to the insurer included in the message sent to the insurer, the status reason for the status of the message sent to the insurer and the status reason for the request to the insurer included in the message sent to the insurer may each be editable by the agent or broker of the insurance agency or brokerage of the specific one of the agents or brokers.

The insurance management system may, for at least one of the insurers of the plurality of insurers, automatically insert a name of a representative of the at least one insurer in a salutation of the message before the insurance management system automatically sends the message individually to each insurer of the plurality of insurers. The message may include a request for a quote from the plurality of the insurers to underwrite at least one of the one or more existing or potential insurance policies. The at least one way for each insurer of the plurality of insurers to electronically access the associated one or more electronic documents may include one or more of: an attachment of the one or more electronic documents to the message, a link in the message to the one or more electronic documents, a password or code to access the one or more electronic documents, a location of the one or more electronic documents, and a link for the insurer to access the insurance management system.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of a networked insurance industry environment according to one illustrated embodiment, including an insurance management system; a plurality of agencies or brokerages, each with associated devices to provide communications via the insurance management system; and a plurality of insurance companies, underwriters or insurers, each with associated devices to provide communications via the insurance management system.

FIG. 2 is a functional block diagram of an insurance management system networked to an agent or broker operated processor-based device and an insurer underwriter operated processor-based device, according to one illustrated embodiment.

FIG. 3A is a screen print of a first portion of a user interface particularly illustrating a documents and messages panel for an engagement with a particular insured as used by an agent or broker of an agency or brokerage, according to one illustrated embodiment.

FIG. 3B is a screen print of a first portion of the user interface particularly illustrating a submissions panel for an engagement with a particular insured as used by an agent or broker of an agency or brokerage, according to one illustrated embodiment.

FIG. 3C is a screen print of the first portion of the user interface of FIG. 3B particularly illustrating a line of business selection menu as used by an agent or broker of an agency or brokerage, according to one illustrated embodiment.

FIG. 3D is a screen print of the first portion of the user interface of FIG. 3B particularly illustrating an insurance company selection menu as used by an agent or broker of an agency or brokerage, according to one illustrated embodiment.

FIG. 3E is a screen print of the first portion of the user interface of FIG. 3B particularly illustrating an insurance company representative selection menu as used by an agent or broker of an agency or brokerage, according to one illustrated embodiment.

FIG. 3F is a screen print of the first portion of the user interface of FIG. 3B particularly illustrating a document selection menu as used by an agent or broker of an agency or brokerage, according to one illustrated embodiment.

FIG. 3G is a screen print of the first portion of the user interface of FIG. 3B particularly illustrating selected message attributes and a message text entry field as used by an agent or broker of an agency or brokerage, according to one illustrated embodiment.

FIG. 4A is a screen print of a first customized message sent to one of a plurality of insurance companies by the agent or broker of an agency or brokerage, according to one illustrated embodiment.

FIG. 4B is a screen print of a second customized message sent to different one of the plurality of insurance companies by the agent or broker of an agency or brokerage, according to one illustrated embodiment.

FIG. 5A is a screen print of the first portion of the user interface of FIG. 3B particularly illustrating messages sent to a plurality of insurance companies as part of a submission for a particular insured, according to one illustrated embodiment.

FIG. 5B is a screen print of the first portion of the user interface of FIG. 3A particularly illustrating a message sent to a particular insurance company as part of a submission for a particular insured, according to one illustrated embodiment.

FIG. 6 is a screen print of the first portion of the user interface of FIG. 3A particularly illustrating a documents and messages panel for an engagement with a particular insured as used by an insurance company to whom the message was sent, according to one illustrated embodiment.

FIG. 7 is a schematic diagram of a portion of a database stored to a nontransitory computer- or processor-readable medium, including a number of data structures useful in implementing the operation of the insurance management system, according to one illustrated embodiment.

FIG. 8 is a flow diagram showing a method of operation of an insurance management system to automate and/or manage communications between one or more agents or brokers and one or more underwriters of a number of insurers by associating a plurality of underwriters with an electronic message, according to one illustrated embodiment.

FIG. 9 is a flow diagram showing a method of operation of an insurance management system useful in the method of FIG. 8 by automatically sending the message to the associated plurality of underwriters, according to one illustrated embodiment.

### DETAILED DESCRIPTION

In the following description, certain specific details are set forth in order to provide a thorough understanding of various disclosed embodiments.

However, one skilled in the relevant art will recognize that embodiments may be practiced without one or more of these specific details, or with other methods, components, materials, etc. In other instances, well-known structures associated with computer systems, server computers, and/or communications networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The terms agency and brokerage, as well as related terms such as agent and broker, are used interchangeably herein, to refer to the entity that interacts with the consumer, policyholder or insured.

The terms consumer is used herein to refer to a potential purchaser of insurance, as well as to an entity that has an existing insurance policy in place or bound (i.e., policyholder or insured). The terms policyholder and insured are used herein interchangeably to refer to an entity with an existing insurance policy in place or bound.

The terms insurance carriers or insurer are used interchangeably herein to refer entities that underwrite the risk or eventually that is being insured against, by issuance of one or more insurance policies. While the term underwriter is commonly used to refer to a person or business entity that engages in the insurance business, to avoid confusion the term underwriter will be used herein and in the claims to refer to an individual who assesses risks and/or determines premiums in their work for an insurer.

The headings and Abstract of the Disclosure provided herein are for convenience only and do not interpret the scope or meaning of the embodiments.

This disclosure describes various systems, methods and articles related to electronic commerce and in particular evaluation of affiliates in electronic commerce. While specific structures and acts associated with particular illustrated embodiments are disclosed, other structures and acts may be employed in other embodiments.

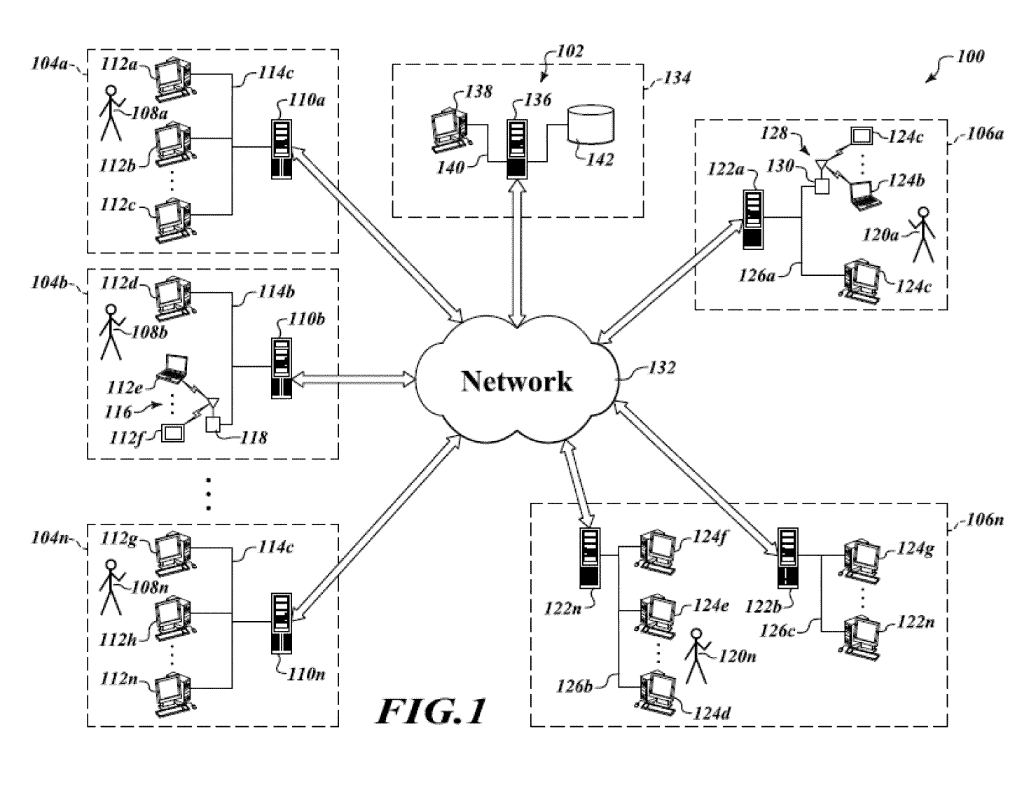

FIG. 1 shows a networked insurance industry environment 100, according to one illustrated embodiment.

The networked insurance industry environment 100 includes an insurance management system 102, a plurality of agencies or brokerages 104a, 104b-104n (three shown, collectively 104), and a plurality of insurance carriers, underwriters or insurers 106a-106n (two shown, collectively 106).

The agencies or brokerages 104 may take any variety of forms, for example being of any of a variety of sizes (e.g., one to hundreds of agents or brokers). The agencies or brokerages 104 will typically be independent, that is capable of writing policies underwritten by various ones of the insurers 106. Each agency or brokerage 104 will typically have one or more agents or brokers 108a, 108b-108n (one agent or broker per agency shown, collectively 108). As described in the background section, agents or brokers 108 typically interact directly with the consumer, policyholder or insured (not illustrated).

Each agency or brokerage 104 may have one or more server computers 110a, 110b-110n (only one per agency 104 shown, collectively 110) to provide electronic communications either externally from and/or internally within the agency or brokerage 104. Agencies or brokerages 104 may often have more than one server computer system 110, particularly where the size of the agency or brokerage 104 or the amount of business handled by the agency or brokerage 104 justifies a larger number of server computer systems 110. Each agency or brokerage 104 may have a number of processor-based devices 112a, 112b, 112c, 112d, 112e, 112f, 112g, 112h-112n (three shown per agency 104, collectively 112). The processor-based devices 112 may take a variety of forms which allow input and output by an end user (e.g., agent or broker 108). For example, the processor-based devices may take the form of personal computers 112a-112d, 112g-112n, laptop or notebook computers 112e, or tablet computers 112f. The processor-based devices 112 may be communicatively coupled to the respective server computers 110 via one or more networks, for example one or more wired (e.g., electrical conductors, optical fibers) networks 114a, 114b-114n (only one per agency or brokerage 104 shown, collectively 114) and/or wireless networks 116 (only one shown) via one or more wireless access points 118 (only one shown).

The insurers 106 may take any variety of forms, typically constituting a relatively large organization. As explained in the background section, each insurer 106 may provide or underwrite insurance policies on some subset of all possible lines of business. Each insurer 106 may typically have one or more underwriters 120a, 120n (one underwriter per insurer 106 shown, collectively 120). The underwriters 120 typically interact directly with the agents or brokers 108, assess risks and/or determine premiums.

Each insurer 106 may have one or more server computers 122a, 122b-122n (three shown, collectively 122) to provide electronic communications either externally from and/or internally within the insurer 106. Given the size of most insurers 106, insurers will typically have more than one server computer system 122. Each insurer 106 may have a number of processor-based devices 124a, 124b, 124c, 124d, 124e, 124f, 124g-124n (eight shown, collectively 124). The processor-based devices 124 may take a variety of forms which allow input and output by an end user (e.g., underwriter 108). For example, the processor-based devices may take the form of personal computers 124a, 124d-124n, laptop or notebook computers 124b, or tablet computers 124c. The processor-based devices 124 may be communicatively coupled to the respective server computers 110 via one or more networks, for example one or more wired networks 114a, 114b-114n (only one per insurer 106 shown, collectively 114) and/or wireless networks 128 (only one shown) via one or more wireless access points 130 (only one shown).

The insurance management system 102 operates as an intermediary between the processor-based devices 112 of the agencies or brokerages 104 and the processor-based devices 124 of the insurers 106, electronically communicating over one or more networks, for example over a wide area network 132 such as the Internet or an extranet. The insurance management system 102 may be operated by a separate entity 134 from the agencies or brokerages 104 and insurers 106, ensuring fair access to all parties.

The insurance management system 102 may have one or more server computers 136 (only one illustrated) to provide electronic communications either externally from and/or internally within the entity 134. To handle the load of multiple agencies or brokerages 104 and multiple insurers 106, the insurance management system 102 will typically have more than one server computer system 136. The insurance management system 102 may include one or more terminals or personal computers 138 (only one shown), communicatively coupled to the server computer 136 via one or more wired or wireless networks 140 (only one shown). The terminals or personal computers 138 allow input and output by an end user (e.g., employee or contractor of the entity 134).

The insurance management system 102 includes at least one nontransitory computer- or processor readable storage medium 142. The nontransitory computer- or processor readable storage medium 142 stores a variety of information about the agencies or brokerages 104, agents or brokers 108, insurers 106 and/or underwriters 120, facilitating the automation and management of communications therebetween, including the transmission of electronic correspondence including electronic messages and/or electronic or digital documents.

At times it may be necessary or desirable to share some or all of the electronic or digital documents or files between one or more of the entities (e.g., agencies or brokerages 104, insurers 106, and/or consumers, policyholders or insureds (not shown). Sharing the electronic or digital documents or files may include allowing interactions with such files, for example, viewing, modifying, copying, annotating, importing, and/or deleting. Additionally, or alternatively, it may be desirable to change ownership for one or more of the electronic or digital documents or files. The terms electronic and digital are used interchangeably herein and in the claims. For example, such terms are used to modify the noun “document,” to indicate a set of data that is in a format suitable for use by a processor-based device, for storage in computer- or processor-readable form, or for transmission via a communications network. As used herein and in the claims, the term “document” includes single page or multiple page documents, whether in the form of a text or alphanumeric based binary file (e.g., ASCII, or .doc, .docx, .xlb file extensions), in the form of an image (e.g., binary image, vector based image, Portable Data File or PDF®) of a text, alphanumeric or graphic based document, or in the form of a markup language based file (e.g., HTML, XML).

In some implementations, the nontransitory computer- or processor readable storage medium 142 may constitute a common electronic document repository to store electronic or digital documents or files. As used herein and in the claims, the term “common electronic document repository” means electronic or digital document or file storage media which is shared by two or more networked nodes, such as two or more servers 110, 122 associated with agencies or brokerages 104 and/or insurers 106, and hence is common to at least two network nodes. The common electronic document repository may be implemented in one or across more than one computer- or processor-readable storage media (e.g., write once read many). The common electronic document repository may include one or more databases which state information or data regarding the electronic or digital documents or files. Such database(s) may be stored separately from the electronic or digital documents, for example, on storage medium that may be rewritten many times (e.g., hard drive, RAID, RAM). The common electronic document repository may be co-located with the insurance management system 102, for example in the same room, building or facility. Alternatively, the common electronic document repository may be located remotely from the insurance management system 102, for example in a different facility, city, state or country. Electronic or digital documents or files are collections of information stored at specific locations in non-transitory computer- or processor-readable media, thus are logically addressable portions of such media, which may or may not be contiguous.

While FIG. 1 illustrates a representative networked insurance industry environment, typical networked insurance industry environments may include many additional computer systems and entities. The concepts taught herein may be employed in a similar fashion with more populated networked insurance industry environments.

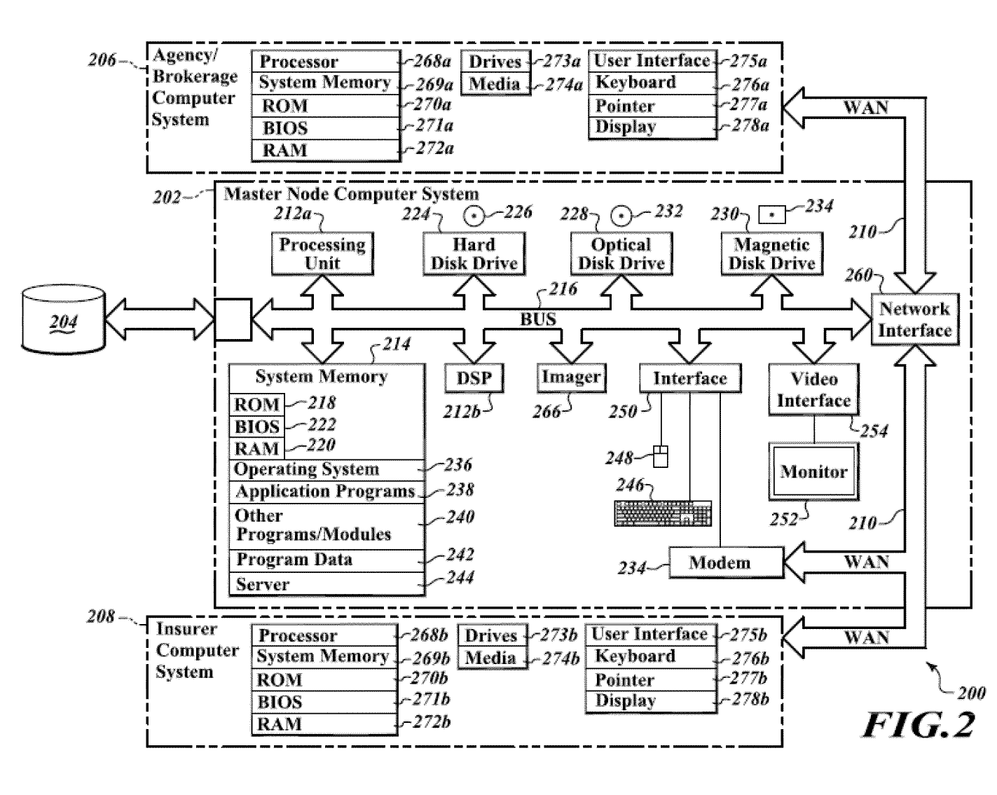

FIG. 2 and the following discussion provide a brief, general description of a suitable networked insurance industry environment 200 in which the various illustrated embodiments can be implemented. Although not required, the embodiments will be described in the general context of computer-executable instructions, such as program application modules, objects, or macros stored on computer- or processor-readable media and executed by a computer or processor. Those skilled in the relevant art will appreciate that the illustrated embodiments, as well as other embodiments, can be practiced with other system configurations and/or other computing system configurations, including hand-held devices, multiprocessor systems, microprocessor-based or programmable consumer electronics, personal computers (“PCs”), networked PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices or media.

FIG. 2 shows a networked insurance industry environment 200 comprising one or more insurance management system server computer systems 202 (only one illustrated) and one or more associated nontransitory computer- or processor readable storage medium 204 (only one illustrated). The associated nontransitory computer- or processor readable storage medium 204 is communicatively coupled to the insurance management system server computer system(s) 202 via one or more communications channels, for example one or more parallel cables, serial cables, or wireless channels capable of high speed communications, for instance via Firewire®.

The networked insurance industry environment 200 also comprises one or more agency or brokerage associated computer systems 206 (only one illustrated) and one or more insurance carrier or insurer associated computer systems 208 (only one illustrated). The agency or brokerage associated computer systems 206 and the insurance carrier or insurer associated computer systems 208 are communicatively coupled to the insurance management system server computer system(s) 202 by one or more communications channels, for example one or more wide area networks (WANs) 210, for instance the Internet using Internet protocols. In operation, the agency or brokerage associated computer systems 206 and/or the insurance carrier or insurer associated computer systems 208 typically function as either a server to other end user computer systems (i.e., clients) associated with a respective entity (e.g., agency, brokerage, insurer) or function as end user computer systems (i.e., clients) themselves. In operation, the insurance management system server computer system(s) 202 typically functions as a server with respect to the agency or brokerage associated computer systems 206 and/or the insurance carrier or insurer associated computer systems 208.

The networked insurance industry environment 200 may employ other computer systems and network equipment, for example additional servers, proxy servers, firewalls, routers and/or bridges. The insurance management system server computer system(s) 202 will at times be referred to in the singular herein, but this is not intended to limit the embodiments to a single device since in typical embodiments there may be more than one insurance management system server computer system(s) 202 involved. Unless described otherwise, the construction and operation of the various blocks shown in FIG. 2 are of conventional design. As a result, such blocks need not be described in further detail herein, as they will be understood by those skilled in the relevant art.

The insurance management system server computer system(s) 202 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and/or a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the master node server computer system 202, such as during start-up.

The insurance management system server computer system(s) 202 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable media 226, 232, 234, provide nonvolatile storage of computer-readable instructions, data structures, program modules and other data for the master node server computer system 202. Although the depicted insurance management system server computer system(s) 202 is illustrated employing a hard disk 224, optical disk 228 and magnetic disk 230, those skilled in the relevant art will appreciate that other types of computer-readable media that can store data accessible by a computer may be employed, such as WORM drives, RAID drives, magnetic cassettes, flash memory cards, digital video disks (“DVD”), Bernoulli cartridges, RAMs, ROMs, smart cards, etc.

Program modules can be stored in the system memory 214, such as an operating system 236, one or more application programs 238, other programs or modules 240 and program data 242. Application programs 238 may include instructions that cause the processor(s) 212 to automatically store to the associated nontransitory computer- or processor readable storage medium 204 logical relationships between identifiers associated with agents and/or brokers and identifiers associated with selected underwriters of insurers. Application programs 238 may include instructions that cause the processor(s) 212 to automatically control access to certain information based on certain criteria. For example, the instructions may limit agents or brokers from seeing information about a specific underwriter of an insurer, unless the agent or broker has previously identified the specific underwriter. Application programs 238 may include instructions that cause the processor(s) 212 to automatically send, transmit, transfer, or otherwise provide electronic communications from an agent or broker to a set of underwriters of an insurer based on sets of underwriters defined or identified as affiliated by or with the agent or broker. Such may include sending, transmitting, transferring or otherwise providing access to electronic or digital documents or files to the set of underwriters of an insurer defined or identified as affiliated by or with the particular agent or broker. Such may allow an agent or broker to seamlessly automatically distribute electronic communications and documents, for instance a request for a policy quote along with supporting data and/or documentation, to a plurality of different underwriters of insurers with which the agent or broker has an existing defined relationship by the agent selecting an icon or button. The request for a policy quote may be automatically customized for each particular recipient insurer or underwriter, such as by inserting the name of the particular recipient insurer or underwriter in the message before sending it.

Different sets of underwriters may be configured for various specific lines of business which are handled by the respective underwriters or their associated insurers. Thus, an agent or broker may affiliate a first set of underwriters for a first line of business or lines of business, and may affiliate a second set of underwriters for a second line of business or lines of business. Application programs 238 may include instructions that cause the processor(s) 212 to automatically establish, maintain, update or record relationship or affiliation information. Such may include logical relationships between agents or brokers and affiliated underwriters of insurers. Such may include relationships between underwriters and insurers, for instance adding new underwriter as they are hired by an insurer or deleting old underwriters as they leave the employ of the insurer. Such may include relationships between agents or brokers and agencies or brokerages, for instance adding new agents or brokers as they are hired by an agency or brokerage or deleting old agents or brokers as they leave the employ of the agency or brokerage. Such may include updating records in a database or table. Application programs 238 may include instructions that cause the processor(s) 212 to automatically establish, maintain, update or record ownership information with respect to electronic or digital documents or files, as well as privileges, permissions or authorizations to perform various acts on such electronic or digital documents or files such as reading, modifying, annotating, importing, and/or deleting. Application programs 238 may even further include instructions to create entries in and/or query one or more databases which store information or data about agencies, agents or brokers, insurer, underwriters of insurers, and/or the electronic or digital documents or files, regardless of location at which those electronic or digital documents are stored. Other program modules 240 may include instructions for handling security such as password or other access protection and communications encryption. The system memory 214 may also include communications programs, for example a server 244 that causes the master node server computer system 202 to serve electronic or digital documents or files via corporate intranets, extranets, or other networks as described below. The server 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of suitable severs may be commercially available such as those from Mozilla, Google, Microsoft and Apple Computer.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230.

An operator can enter commands and information into the management system server computer system(s) 202 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The insurance management system server computer system(s) 202 can include other output devices, such as speakers, printers, etc.

The insurance management system server computer system(s) 202 can operate in a networked environment using logical connections to one or more remote computers and/or devices. For example, the insurance management system server computer system(s) 202 can operate in a networked environment using logical connections to one or more agency or brokerage associated computer systems 206 and the insurance carrier or insurer associated computer systems 208. Communications may be via a wired and/or wireless network architecture, for instance wired and wireless enterprise-wide computer networks, intranets, extranets, and/or the Internet. Other embodiments may include other types of communications networks including telecommunications networks, cellular networks, paging networks, and other mobile networks. There may be any variety of computers, switching devices, routers, bridges, firewalls and other devices in the communications paths between the insurance management system server computer system(s) 202 and the agency or brokerage associated computer systems 206 and the insurance carrier or insurer associated computer systems 208.

The agency or brokerage associated computer systems 206 and the insurance carrier or insurer associated computer systems 208 will typically take the form of end user processor-based devices, for instance personal computers (e.g., desktop or laptop computers), netbook computers, tablet computers and/or smartphones and the like, executing appropriate instructions. These end user processor-based devices may be communicatively coupled to one or more server computers. For instance, agency or brokerage devices may be communicatively coupled externally from the respective agency or brokerage via one or more agency or brokerage server computers, which may implement a firewall. For instance, insurer devices may be communicatively coupled externally from the respective insurer via one or more insurer server computers, which may implement a firewall. The server computers may execute a set of server instructions to function as a server for a number of end user computer systems (i.e., clients) communicatively coupled via a LAN at a facility or site. The end user computer systems 206, 208 may execute a set of client instructions to function as a client of the server computer(s), which are communicatively coupled via a WAN.

The agency or brokerage associated computer systems 206 and the insurance carrier or insurer associated computer systems 208 may include one or more processing units 268a, 268b (collectively 268), system memories 269a, 269b (collectively 269) and a system bus (not shown) that couples various system components including the system memory 269 to the processing unit 268. The agency or brokerage associated computer systems 206 and the insurance carrier or insurer associated computer systems 208 will at times each be referred to in the singular herein, but this is not intended to limit the embodiments to a single agency or brokerage associated computer system 206 and/or the insurance carrier or insurer associated computer systems 208. In typical embodiments, there may be more than one agency or brokerage associated computer systems 206 and there will likely be a large number of insurance carrier or insurer associated computer systems 208.

The processing unit 268 may be any logic processing unit, such as one or more central processing units (CPUs), digital signal processors (DSPs), application-specific integrated circuits (ASICs), field programmable gate arrays (FPGAs), etc. Non-limiting examples of commercially available computer systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation. Unless described otherwise, the construction and operation of the various blocks of the satellite node server computer systems 206 shown in FIG. 2 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 269 includes read-only memory (“ROM”) 270a, 270b (collectively 270) and random access memory (“RAM”) 272a, 272b (collectively 272). A basic input/output system (“BIOS”) 271a, 271b (collectively 271), which can form part of the ROM 270, contains basic routines that help transfer information between elements within the end user computer systems 206, 208, such as during start-up.

The agency or brokerage associated computer systems 206 and the insurance carrier or insurer associated computer systems 208 may also include one or more media drives 273a, 273b (collectively 273), e.g., a hard disk drive, magnetic disk drive, WORM drive, and/or optical disk drive, for reading from and writing to computer-readable storage media 274a, 274b (collectively 274), e.g., hard disk, optical disks, and/or magnetic disks. The computer-readable storage media 274 may, for example, take the form of removable media. For example, hard disks may take the form of a Winchester drives, and optical disks can take the form of CD-ROMs, while magnetic disks can take the form of magnetic floppy disks or diskettes. The media drive(s) 273 communicate with the processing unit 268 via one or more system buses. The media drives 273 may include interfaces or controllers (not shown) coupled between such drives and the system bus, as is known by those skilled in the relevant art. The media drives 273, and their associated computer-readable storage media 274, provide nonvolatile storage of computer readable instructions, data structures, program modules and other data for the agency or brokerage associated computer systems 206 and/or the insurance carrier or insurer associated computer systems 208. Although described as employing computer-readable storage media 274 such as hard disks, optical disks and magnetic disks, those skilled in the relevant art will appreciate that end user computer systems 206, 208 may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, electronic or digital documents or files or data (e.g., metadata, ownership, authorizations) related to such can be stored in the computer-readable storage media 274.

Program modules, such as an operating system, one or more application programs, other programs or modules and program data, can be stored in the system memory 269. Program modules may include instructions for accessing a Website, extranet site or other site or services (e.g., Web services) and associated WebPages, other pages, screens or services hosted by the insurance management system 102. Program modules may include instructions for storing certain or selected electronic correspondence and/or electronic or digital documents or files or changes thereto to nontransitory computer- or processor readable storage medium, such as local media 274a, 274b, or remote media 142 (FIG. 1), 204, 226, 232, 234. Alternatively, the instructions may cause retrieval of electronic correspondence and/or electronic or digital documents or files or changes to existing electronic correspondence and/or electronic or digital documents or files. Program modules may additionally include instructions for handling security such as ownership, password or other access protection and communications encryption.

In particular, the system memory 269 may include communications programs that permit the agency or brokerage associated computer systems 206 and the insurance carrier or insurer associated computer systems 208 to retrieve electronic correspondence and/or electronic or digital documents or files from the associated nontransitory computer- or processor readable storage medium 204. The system memory 269 may additionally include communications programs that permit the agency or brokerage associated computer systems 206 and the insurance carrier or insurer associated computer systems 208 to gain access to or retrieve electronic correspondence and/or electronic or digital documents or files from the local electronic document repository 204 of another satellite node, via the insurance management system server computer system(s) 202, if the requesting agency or brokerage associated computer systems 206 and the insurance carrier or insurer associated computer systems 208 have sufficient right, permission, privilege or authority. The system memory 269 may also include other communications programs, for example a Web client or browser that permits the agency or brokerage associated computer systems 206 and the insurance carrier or insurer associated computer systems 208 to access and exchange data with sources such as Web sites of the Internet, corporate intranets, extranets, or other networks. The browser may, for example be markup language based, such as Hypertext Markup Language (HTML), Extensible Markup Language (XML) or Wireless Markup Language (WML), and may operate with markup languages that use syntactically delimited characters added to the data of a document to represent the structure of the document.

While described as being stored in the system memory 269, the operating system, application programs, other programs/modules, program data and/or browser can be stored on the computer-readable storage media 274 of the media drive(s) 273. An operator can enter commands and information into the agency or brokerage associated computer systems 206 and the insurance carrier or insurer associated computer systems 208 via a user interface 275a, 275b (collectively 275) through input devices such as a touch screen or keyboard 276a, 276b (collectively 276) and/or a pointing device 277a, 277b (collectively 277) such as a mouse. Other input devices can include a microphone, joystick, game pad, tablet, scanner, etc. These and other input devices are connected to the processing unit 269 through an interface such as a serial port interface that couples to the system bus, although other interfaces such as a parallel port, a game port or a wireless interface or a universal serial bus (“USB”) can be used. A display or monitor 278a, 278b (collectively 278) may be coupled to the system bus via a video interface, such as a video adapter. The satellite node server computer system 206 can include other output devices, such as speakers, printers, etc.

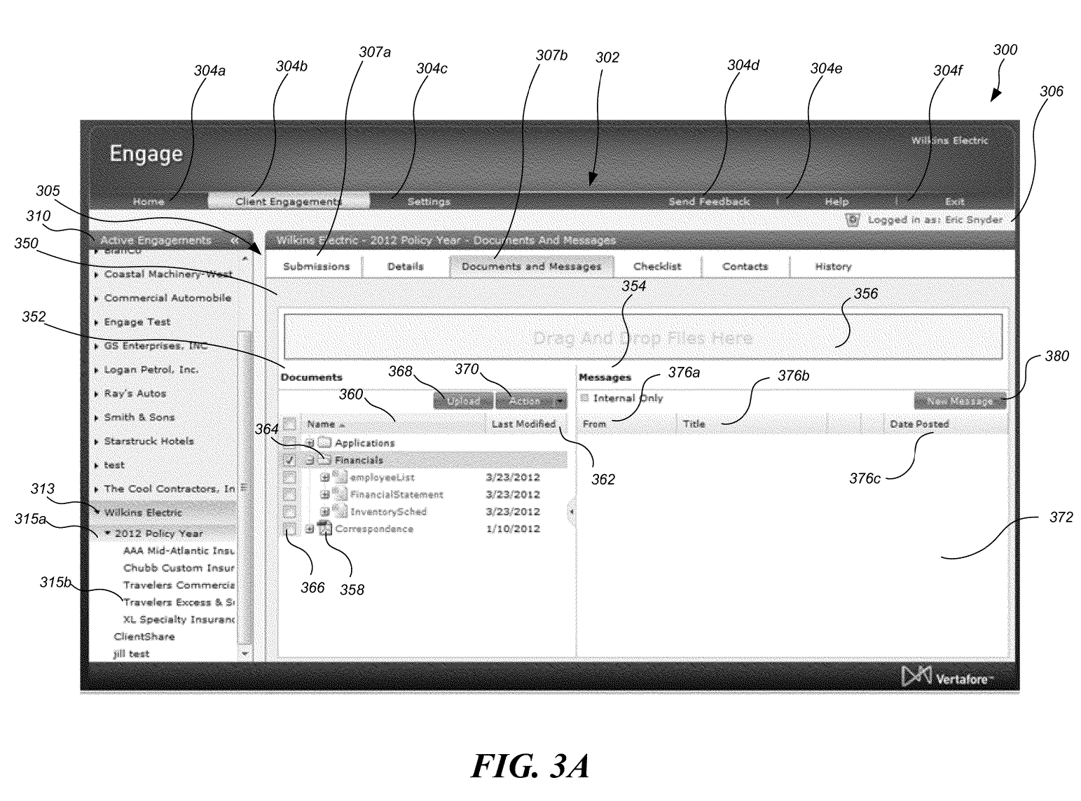

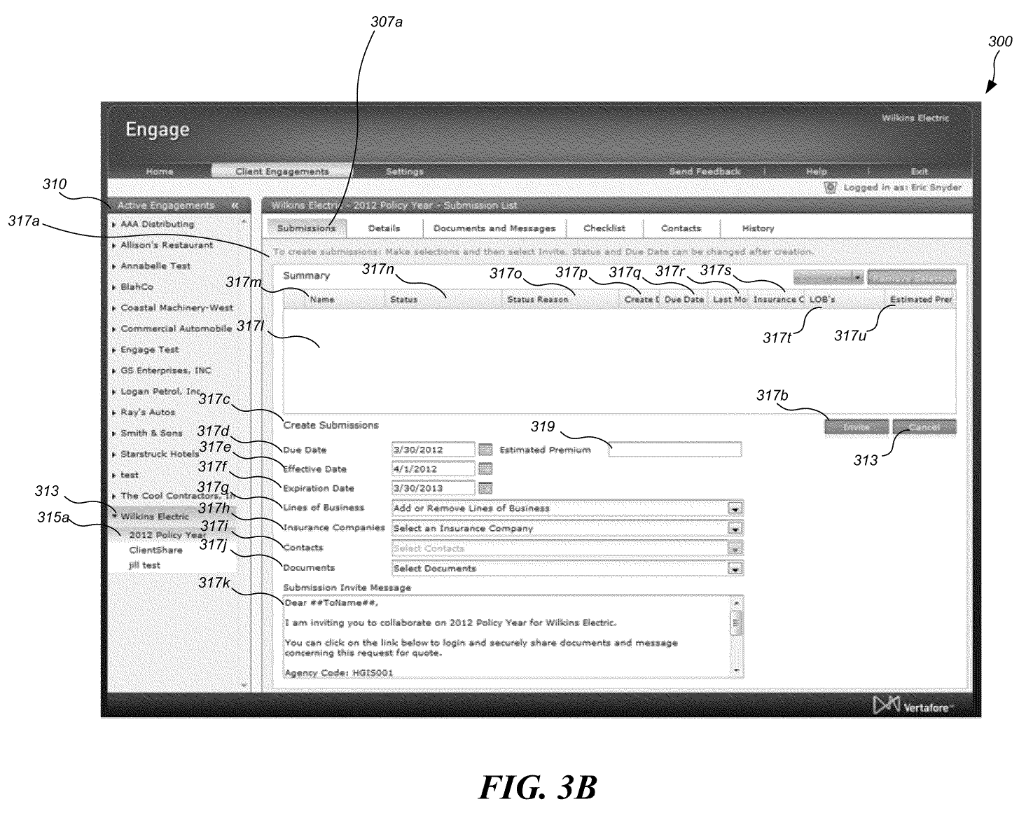

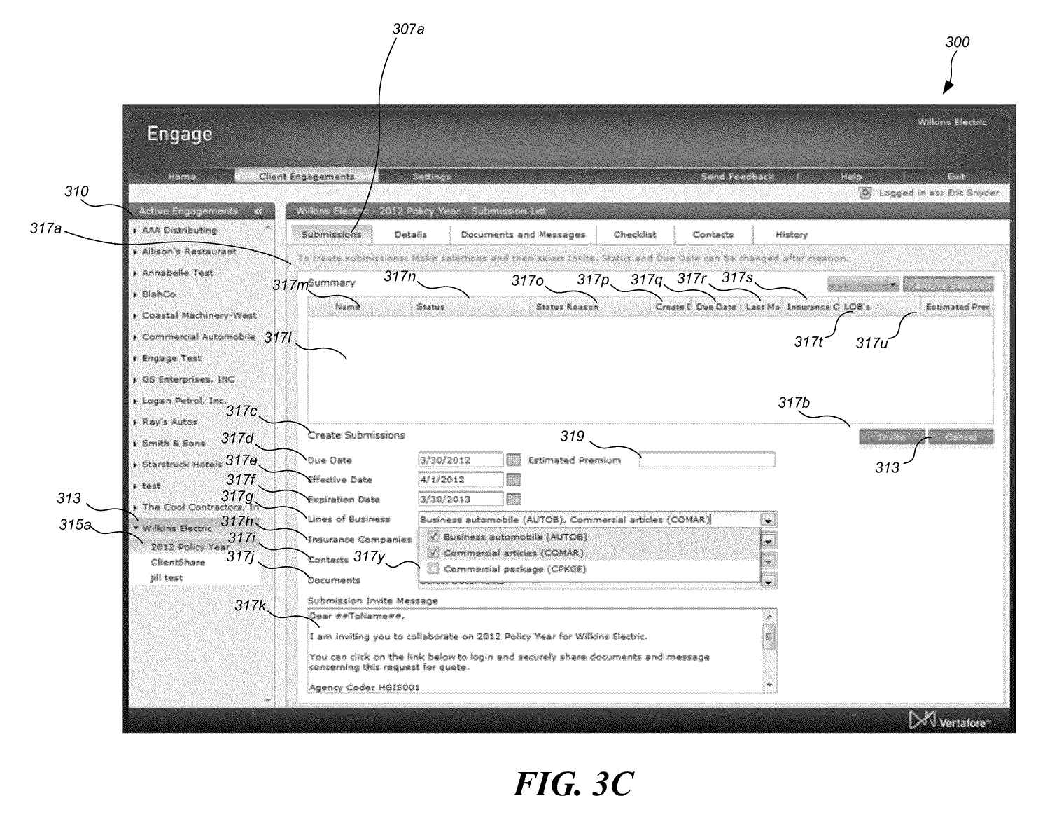

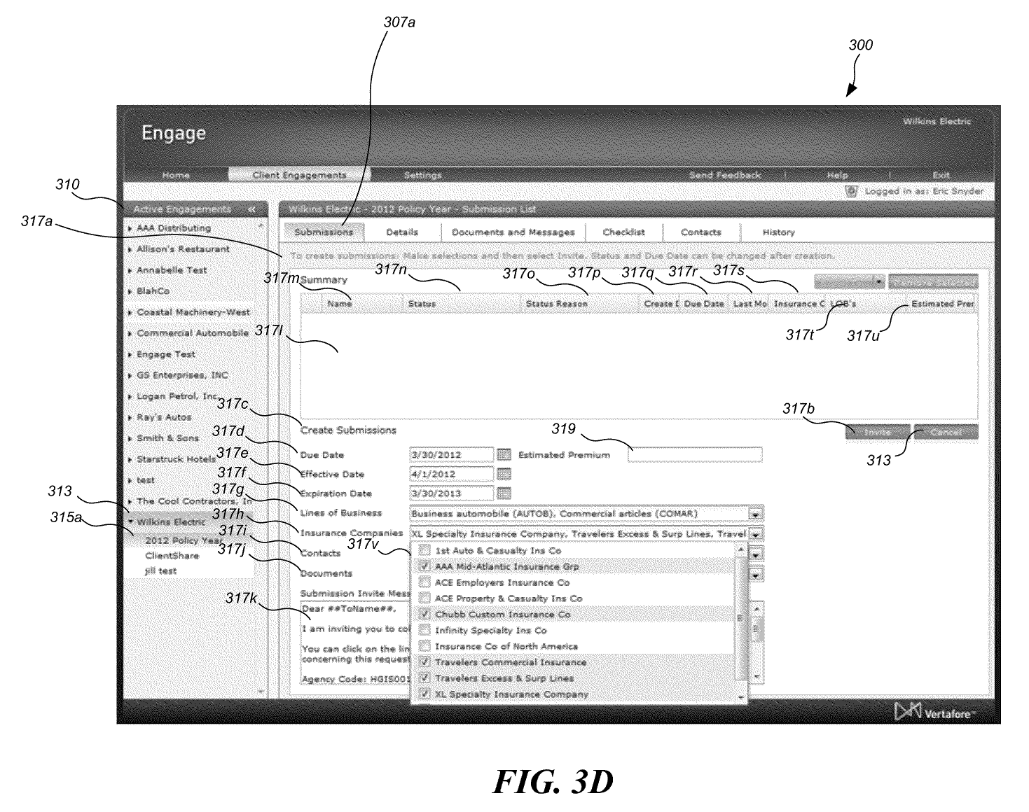

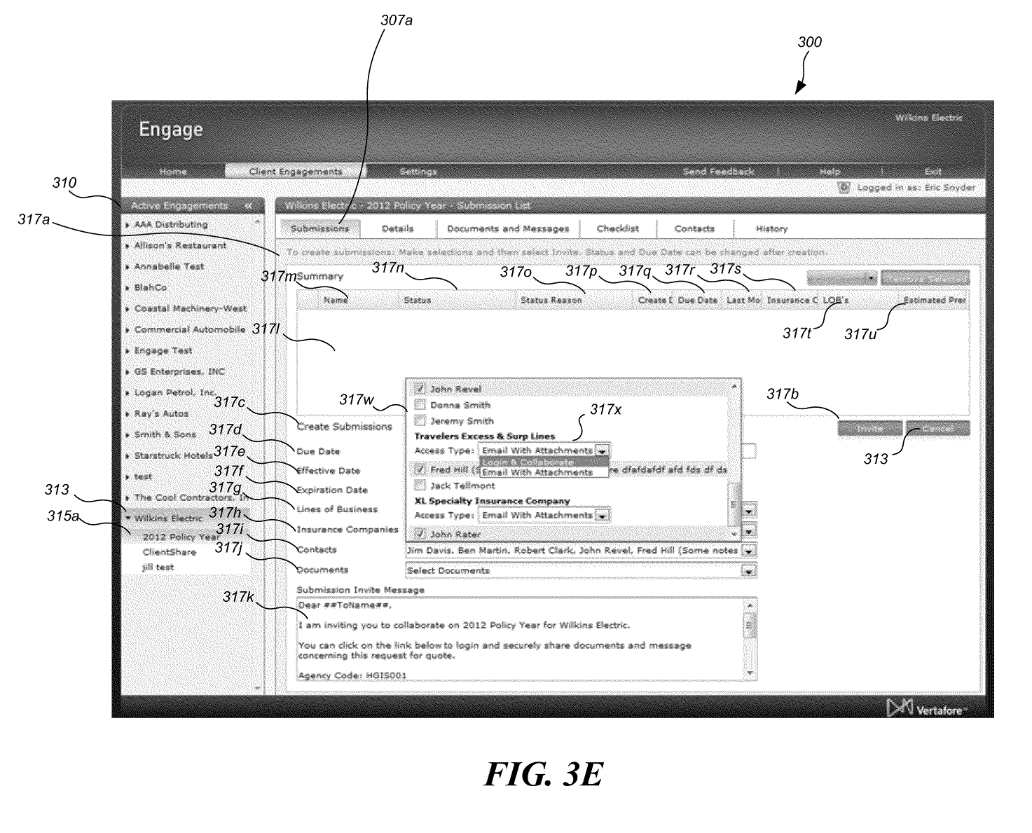

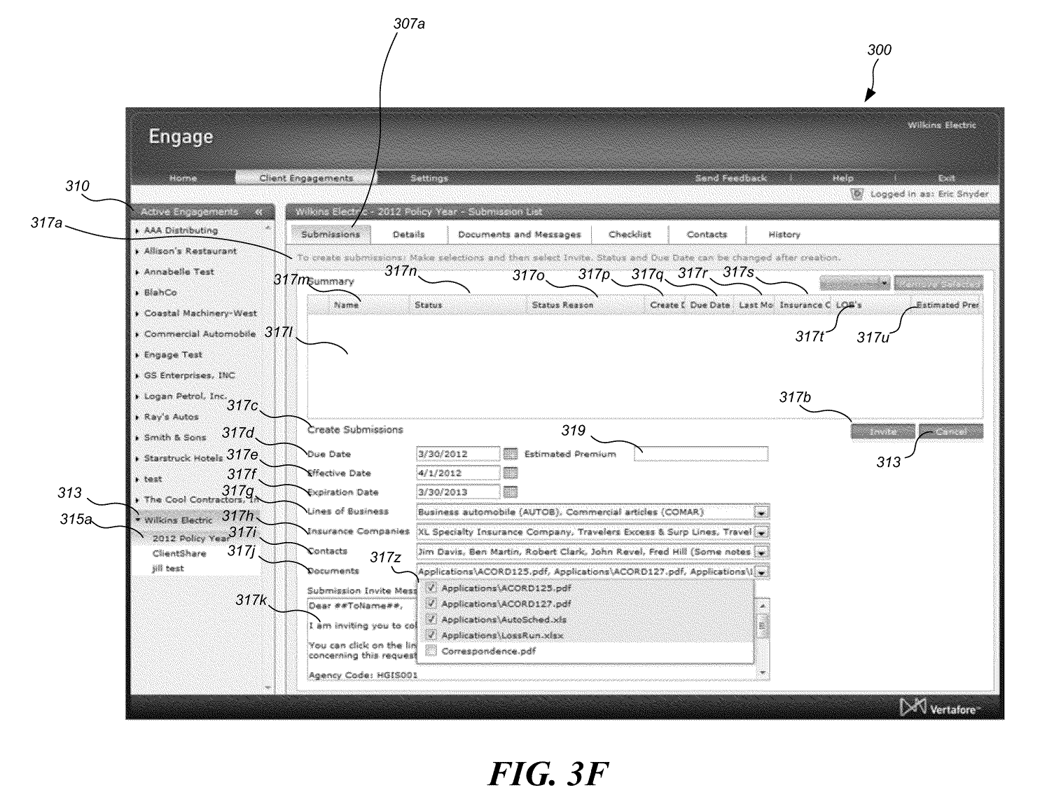

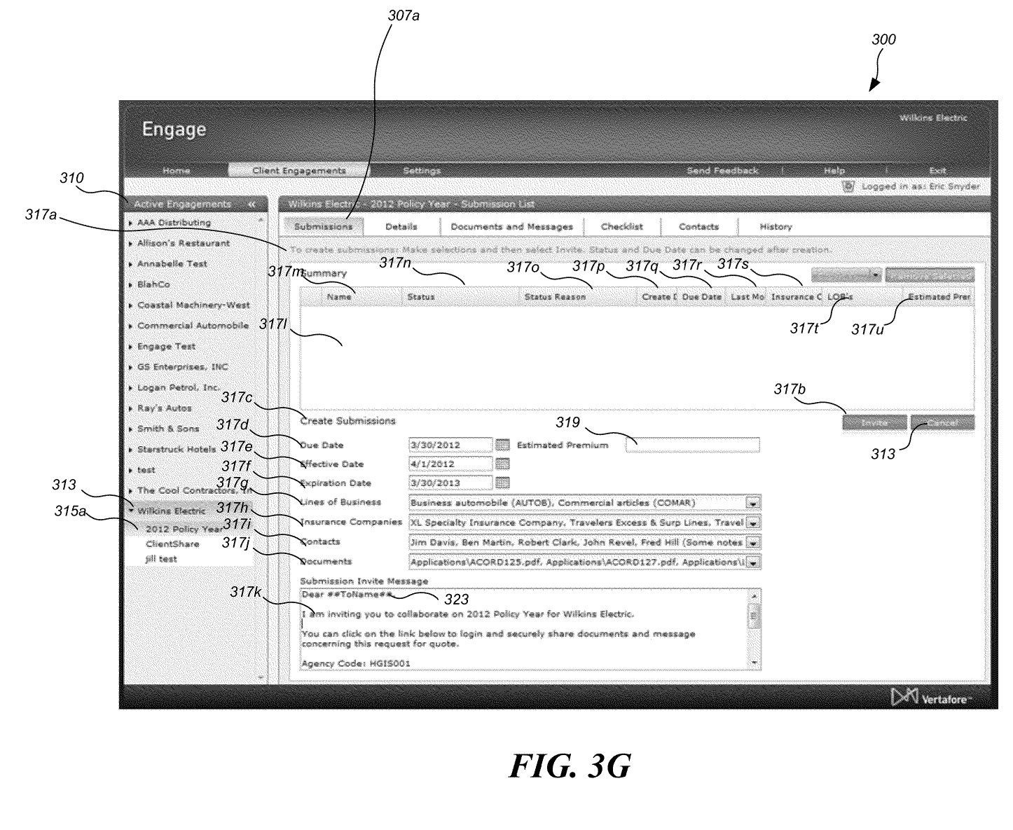

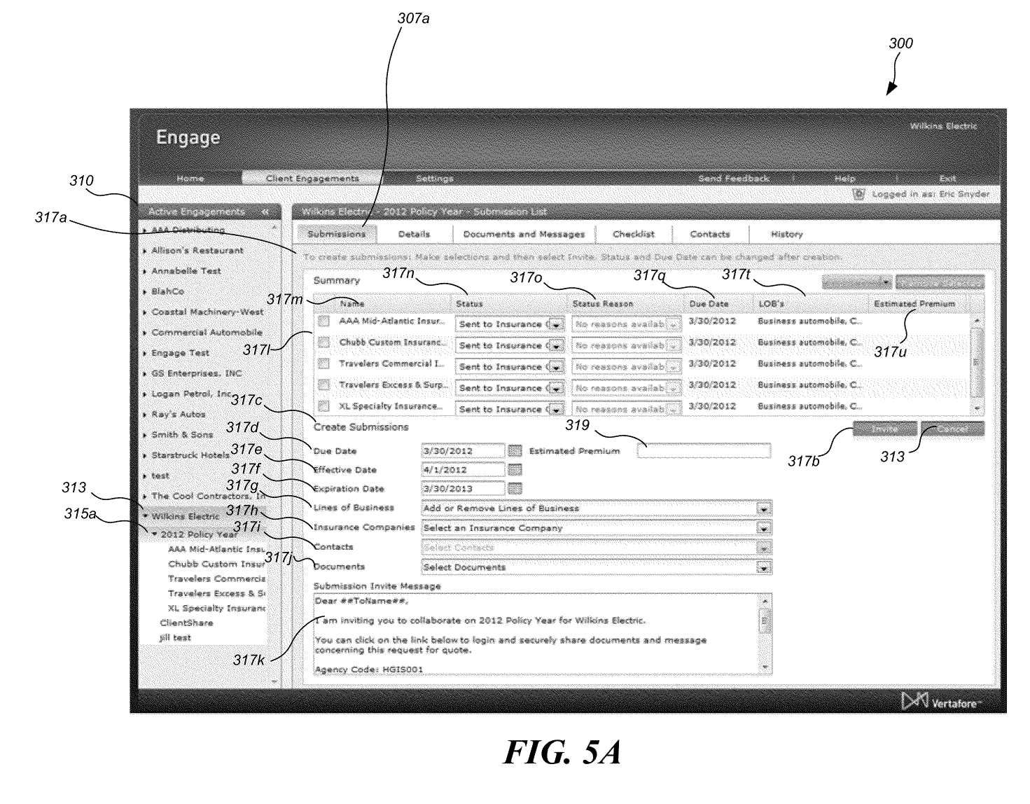

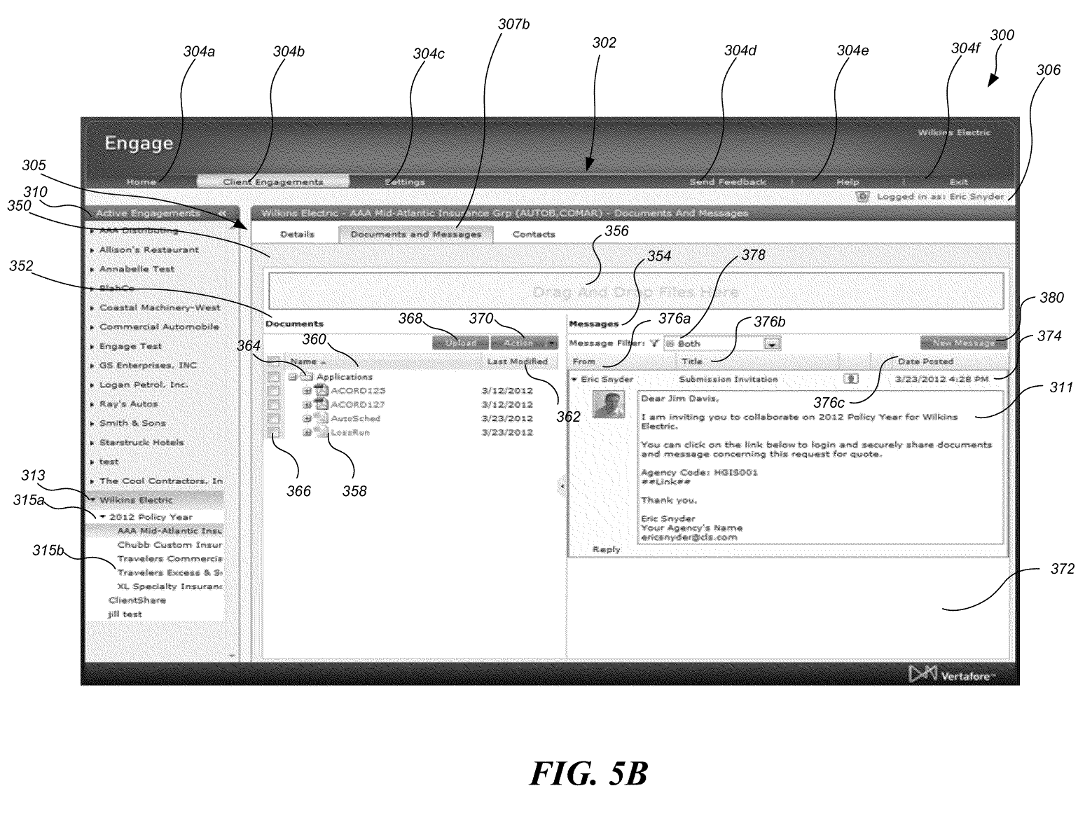

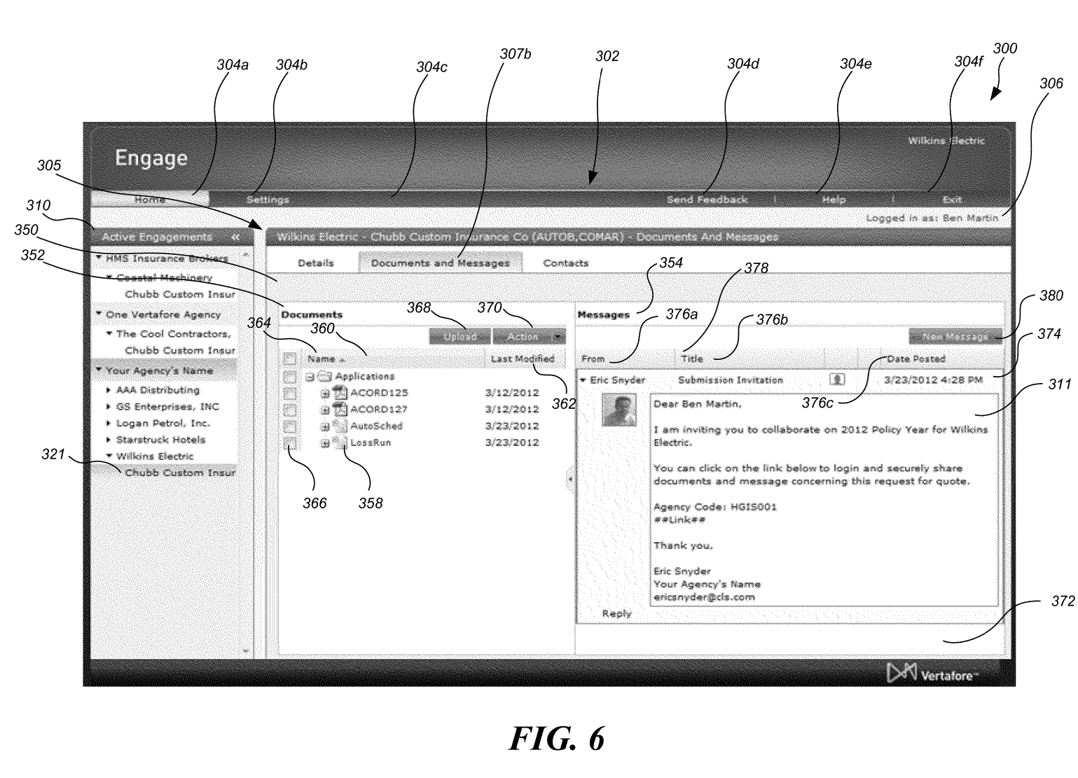

FIG. 3A, FIG. 5B and FIG. 6 show a portion 300 of a user interface particularly illustrating a documents and messages panel as used by an underwriter or an agent or broker of an agency or brokerage.

The portion 300 of the user interface may be presented as a window or screen with a number of user interface components, for instance menus, panels, dialog boxes, radio buttons, expansion controls and plus/minus icons (i.e., icons the selection of which cause a hierarchical list to expand and contract). The terms window and screen are used interchangeably herein to refer to a portion of a user interface (e.g., graphical user interface or GUI), which is displayed on a display or monitor and which provides information (i.e., output) to a user and which may allow the user to provide instructions, commands or information (i.e., input) to a processor-based device or an application executing on a processor-based device.

Many of the user interface components of the portion 300 of the user interface illustrated in FIG. 3A, FIG. 5B and FIG. 6 are identical to one another, the differences being solely in the content of material displayed in or by the various components. Thus, identical or similar components are identified with the same reference numbers across FIG. 3A, FIG. 5B and FIG. 6. Only significantly different components are called out with separate reference numbers.

The portion 300 includes a main menu 302 with a number of user selectable icons or tabs, collectively 304, and a user field 306 that indicates an identity of the user currently logged in to use the system. The main menu 302 may include a home tab user selectable icon or tab 304a, client engagement user selectable icon or tab 304b, settings user selectable icon or tab 304c, send feedback user selectable icon or tab 304d, help user selectable icon or tab 304e, and exit user selectable icon or tab 304f. The user may choose any of the user selectable icon or tabs 304 by selecting the desired user selectable icon or tab with a pointer, for example by manipulating a mouse, trackpad or trackball, touching a touch sensitive display, or tabbing using an appropriate tab key on a keyboard or keypad, or by speaking commands.

Selection of the home user selectable icon or tab 304a causes presentation of a home panel (not shown for agents/brokers). The home panel may provide user interface tools for constructing, transmitting, and/or receiving correspondence such as electronic mail messages and electronic documents. Such may allow an agent or broker to provide the content (e.g., text of message) of the correspondence, identify, attach or provide links to supporting electronic documents (e.g., spreadsheets, PDF documents, images), and specify intended recipients for the electronic correspondence. For example, where correspondence is a request for policy pricing, the correspondence may set out certain details of the policy (e.g., size, amount, length) and may attach one or more electronic documents related to the same request. The electronic documents may, for instance, provide data or information that supports the request.

The user interface may include one or more elements that allow the agent or broker to specify one or more subjects for the correspondence, for instance one or more lines of business to which the correspondence pertains. This may allow the system to automatically determine or identify intended recipients for the correspondence. For example, the system may identify all insurer underwriters that the particular agent or broker has an existing defined logical relationship and who handle the particular lines of business specified. The system may rely on the database schema 700 in assessing such, running appropriate queries against the information in the database.

User selection of the client engagement user selectable icon or tab 304b brings up a client engagement menu 305 including, among other tabs, the submissions tab 307a and the documents and messages tab 307b. Selection of the documents and messages tab 307b brings up the documents and messages panel 350. As shown in FIG. 3A, the documents and messages panel 350 may include a number of subpanels, for example a documents subpanel 352 and a messages subpanel 354, as well as a drag and drop area 356.

The document subpanel 352 provides a set of user selectable document icons 358 (only one called out). The user selectable document icons 358 correspond to each of a number of electronic documents which are associated with the specified consumer, insured, policyholder or project. The electronic documents may take a variety of forms useful in assessing, supporting or otherwise documenting the evaluation, consideration, or assessment of whether to bind a policy, and the specific particulars of such policy such as limits, deductibles, exclusions, endorsements, etc. The document subpanel 352 may include a name field 360 and a date field 362. The name field 360 may indicate a name of the specific document, while the date field 362 may indicate a date on which the specific document was last modified, and/or a date on which the specific document was created.

The user selectable document icons 358 may be arranged in a hierarchical fashion, such as in one or more folders 364 (one called out) of a nested folder structure. Selection of a user selectable expand/collapse icon (i.e., +, −) toggles between expanding and collapsing the contents of folders 364.

Selection of an electronic document, for example by double clicking with a cursor positioned on a corresponding electronic document icon, may cause the specific electronic documents to be opened in an appropriate viewer (e.g., word processing program, spreadsheet program, image viewer program).

Selection of a corresponding checkbox 366 (only one called out) allows a user to select one or more documents for the insurance managements system to perform one or more actions on the selected documents or folders including, but not limited to, adding a new version, copying, or deleting the selected document. Additional actions which may not be related to a corresponding checkbox 366 may include, but are not limited to, the insurance management system organizing or enabling organization of a folder structure in which to organize documents (e.g., by adding a new folder or folder structure in which to organize documents or removing folders). Clicking the Upload icon 368 allows a user to choose and upload multiple documents from other storage devices in to the insurance management system, such as from a local computer or storage device, mobile device, network hard drive or other location. Such may include uploading electronic documents to a central document repository stored on nontransitory computer- or processor-readable media 142 (FIG. 1), to allow access by at least one other party (e.g., agent, broker). Selection of a user selectable action (not illustrated) in an action pull-down menu 370 causes the system to perform an action on, or with respect to, all electronic documents identified by selection of the corresponding checkboxes 366. For example, an electronic document may be updated, marked with a status (e.g., completed, in progress, sent, revised, verified).

The messages subpanel 354 includes a content window 372. The content window 372 presents a set of electronic mail messages (one shown in FIG. 5B). As shown in FIG. 5B, selection of a corresponding expand/collapse icon (i.e., [symbol] , ▾) toggles between presenting and hiding the content of the respective electronic mail message 374. A from field 376a indicates an identity of a sender of the particular electronic mail message. A title field 376b indicates a title of the electronic mail message or name of a project to which the electronic mail message is related. A date posted field 376c indicates a date that the electronic mail message was sent or otherwise posted. The fields 376a-376c are collectively referenced as 376.

A filter pull-down menu 378 allows filtering of electronic messages. Selection of a user selectable new message icon 380 opens a window that allows composition of a new electronic mail message, including entry of content, specification of intended recipient, title, and/or attachment of electronic documents or hyperlinks to electronic documents.

The drag and drop area 356 allows electronic or digital documents or files to be easily and seamlessly incorporated into the system. Thus, documents from external sources may be incorporated, for instance documents residing on an end user's desktop, hard drive, USB stick, received in via electronic mail outside the system, downloaded from a Website or other source.

The use of the active engagements panel 310 allows the end user (e.g., agent, broker) to easily create electronic mail messages and related electronic documents and transmit such to underwriters in an organized fashion, for example selecting projects in the active engagements panel 310 and viewing, creating or attaching related electronic documents in the documents subpanel 352 and related messages in the messages subpanel 354 all on one screen or in one overall window.

Selection of the send feedback icon or tab 304d causes presentation of a feedback panel (not shown), allowing the agent or broker to send, transmit, transfer or otherwise making available feedback to one or more intended recipients (e.g., to a vendor or support entity responsible for creation, maintenance, improvements and/or support of the insurance management system).

Selection of the help icon or tab 304e causes presentation of a help panel or dialog box (not shown), allowing the agent or broker to enter a subject or topic of an inquiry regarding use of the insurance management system to receive help, assistance or pointers.

Selection of the exit icon or tab 304f causes an exiting of the insurance management system on the specific end user processor-based device.

Selection of the settings icon or tab 304c causes presentation of a settings panel (not shown). The settings panel allows the agent or broker to set or modify settings.

The active engagement subpanel 310 provides a set of user selectable client icons 313 (only one called out) which identify and correspond to a number of clients of the agent or broker or of the agency or brokerage. The set of client icons 313 displayed to any given end user (e.g., agent or broker), may be customized for the particular end user. For example, the client icons 313 may identify each client, insured, customer or potential customer who has an existing relationship with an agent or broker, or with an agency or brokerage for which the particular end user works. Selection of a user selectable expand/collapse icon (i.e., [symbol] , ▾) toggles between presenting and hiding the set of client icons 313.

Also, selection of a user selectable expand/collapse icon (i.e., [symbol] , ▾) associated with one of the set of client icons 313, toggles between presenting and hiding a set of user selectable policy year icons 315a associated with the particular client, insured, customer or potential customer identified by the user selectable client icon 313. Furthermore, selection of a user selectable expand/collapse icon (i.e., [symbol] , ▾) associated with one of the set of policy year icons 315a toggles between presenting and hiding set of selectable insurer or underwriter icons 315b representative of particular engagements with that insurer associated with the particular policy year identified by the associated policy year icon of the set of policy year icons 315a. The set of insurer icons 315b displayed to any given end user (e.g., agent or broker), may be customized for the particular end user. For example, the insurer icons 315b may identify each insurer that has an existing relationship with an agency or brokerage for which the particular end user works. This also allows the end user to easily identify potential insurers from whom to solicit bids or policies. As with the set of client icons 313, selection of a user selectable expand/collapse icon (i.e., [symbol] , ▾) toggles between presenting and hiding the set of insurer icons.

For example, selection of the expand/collapse icon (i.e., [symbol] , ▾) icon associated with a particular client identified by one of the set of client icons 313 causes a selectable list of policy years for that customer to appear. Selection of the expand/collapse icon (i.e., [symbol] , ▾) icon associated with a particular policy year will cause a selectable list of existing or potential insurers or underwriters for that policy year representative of particular engagements with that insurer associated with that customer or client. In particular, this allows the end user to easily identify potential insurers from whom to solicit bids or policies for that particular client and for the selected policy year.

Accordingly, selection of one of the set of insurer or underwriter icons 315b representative of particular engagements with that insurer will cause the documents and messages panel 350 to be brought up. The documents and messages for that particular selected client and selected engagement will appear in the documents and messages panel 350.

In some embodiments, selection of one of the set of policy year icons 315a identifying a particular policy year for that customer may cause all the documents and messages associated with that particular customer for that particular policy year to appear in the documents and messages panel 350.

Selection of a user selectable hide/show icon (i.e., <<) toggles between presenting and hiding the active engagement subpanel 310. The active engagement subpanel 310 may additionally appear or be presented in other panels such as panels presented under the home table icon or tab 304a and/or under the settings icon or tab 304c. Selection of one of the insurer icons updates the content of the insurer specification subpanel (not shown), which displays insurer specific information.

FIGS. 3B-3G are screen prints of the portion 300 of the user interface particularly illustrating a submissions panel 317a associated with an engagement for a particular client, insured, customer or potential customer who has an existing relationship with an agent or broker, or with an agency or brokerage for which the particular end user works, as used by the agent or broker. Some of the user interface components of the portion 300 of the user interface illustrated in FIG. 3B are identical or similar to user interface components of the portion 300 of the user interface illustrated in FIGS. 3A, 3C-3G, FIG. 5A and FIG. 5B. The identical or similar components are identified with the same reference numbers in FIG. 3B as were employed in FIGS. 3A, 3C-3G, FIG. 5A and FIG. 5B. Description of identical or similar components will not be repeated, in the interest of brevity. Only significantly different components are called out with separate reference numbers and discussed below.

User selection of the submissions tab 307a brings up the submissions panel 317a. The submissions panel 317a includes user interface tools for constructing and transmitting a submission (e.g., a solicitation for a bid, policy pricing, request for premium quote on a policy, etc.) in the form of electronic mail messages, correspondence to particular insurers or underwriters for the particular client and policy year identified by a selected one of the set of client icons 313 and a selected one of the set of policy year icons 315a in the active engagement subpanel 310. Such may allow an agent or broker to provide the content (e.g., text of message) of the correspondence, identify, attach or provide links to supporting electronic documents (e.g., spreadsheets, PDF documents, images), and specify intended insurers or underwriters to which the submission is to be sent. For example, where the submission is a request for policy pricing, the correspondence may set out certain details of the policy (e.g., size, amount, length) and may attach one or more electronic documents related to the same request. The electronic documents may, for instance, provide data or information that supports the request. Correspondence including the same request for policy pricing may then automatically be sent out to each of the selected insurers or underwriters by the agent selecting the invite icon. The system may rely on the database schema 700 in assessing such addresses for the selected insurers or underwriters, running appropriate queries against the information in the database in conjunction with sending the message.

The submissions panel 317a includes create submissions area 317 including user interface elements that allow the agent or broker to specify one or more items regarding the submission that may be communicated with the submission to each of the insurers or underwriters to which the submission will be sent. The create submission due date field 317d allows the agent or broker to specify the due date of the submission. The create submission effective date field 317f allows the agent or broker to specify the effective date of the submission. The create submission expiration date field 317f allows the agent or broker to specify the expiration date of the submission. The create submission estimated premium field 319 allows the agent or broker to specify an estimated premium for an insurance policy associated with the submission.

The submissions panel 317a includes a submissions summary area 317l in which records of the submissions for the client and policy year selected within the active engagements subpanel 310 are listed. Each record includes a name field 317m, a status field 317n, a status reason field 317o, a create date 317p field, a due date filed 317q, a last modified date field 317r, an insurance company field 317s a lines of business field 317t and an estimated premium field 317u. These fields are explained in more detail with reference to FIG. 5A below. Selection of the “cancel” icon causes the current submission being created in the create submissions area 317c to be canceled and the applicable data fields to be cleared.

The submissions panel 317a also includes a lines of business menu 317g to allow selection of one or more lines of business to which the submission pertains. As shown in FIG. 3C, the lines of business menu 317g includes a selectable list 317y from which the agent or broker may select one or more lines of business to which the submission pertains. This may allow the system to automatically determine or identify intended recipients for the submission. For example, the system may identify all insurer underwriters that the particular agent or broker has an existing defined logical relationship and who handle the particular lines of business specified. As another example, the system may identify particular individual representatives of the insurer underwriters that handle the selected lines of business to which to address the message. The system may rely on the database schema 700 in assessing such, running appropriate queries against the information in the database.

The submissions panel 317a also includes an insurance companies menu 317h to allow selection of one or more insurers or underwriters to which the submission will be sent. As shown in FIG. 3D, the insurance companies menu 317h includes a selectable list 317v from which the agent or broker may select one or more insurers or underwriters to which the submission will be sent. The end user (e.g., insurance agent) may select multiple insurers or underwriters to receive the same submission by selecting check boxes next to the name of the desired insurers or underwriters in the selectable list 317v. The system may rely on the database schema 700 in assessing the email address, network address, or other correspondence information for each selected insurer or underwriter, running appropriate queries against the information in the database.

The submissions panel 317a includes contacts menu 317i to allow selection of one or more individual representatives of the selected insurers or underwriters to which the submission will be sent. As shown in FIG. 3E, the insurance companies menu 317h includes a selectable list 317w from which the agent or broker may select one or more individual representatives of the selected insurers or underwriters to which the submission will be sent.

The system may generate the selectable list 317w such that the representatives are organized in the selectable list 317w under the respective insurers or underwriters which they represent. Also, the system may generate the selectable list 317w such that only representatives from the insurers or underwriters selected from the selectable list 317v are displayed. In some embodiments, the system may generate the selectable list 317w such that only representatives from the insurers or underwriters associated with the lines of business selected from the selectable list 317y are displayed and/or are already pre-selected. The system may rely on the database schema 700 in assessing the email address, network address, or other correspondence information for each selected representative, running appropriate queries against the information in the database.

Proximate to each insurer or underwriter in selectable list 317v is also a selectable list 317x from which the user may select an access type associated with the corresponding insurer or underwriter. The access type indicates the manner, format and/or or way in which the submission and associated documents will be accessed or communicated to the insurer or underwriter once the user selects the “invite” icon 317b. In this manner, the submission may be communicated to each of the selected insurers or underwriters differently without the user having to individually send the submission in each of the different manners or formats for each of the insurers or underwriters. For example, one selected insurer may be emailed a link to log on to the system to access the associated documents, while another selected insurer may be sent an email with the associated documents included as email attachments. In some embodiments, the submission may be automatically faxed, or printed and then mailed to a selected insurer. This may be especially useful if one or more of the selected insurers or underwriters does not have sufficient access to the system.

The submissions panel 317a includes documents menu 317j to allow selection of one or more individual or groups of documents (e.g., such as those previously uploaded using drag and drop area 356 shown in FIG. 3A) to be made part of or attached to the submission. Such documents may include, but are not limited to insurance policy applications, financial records and statements, asset documentation, title documents, or any other documents that may be relevant to a request for policy pricing. As shown in FIG. 3F, the documents menu 317j includes a selectable list 317z from which the agent or broker may select one or more documents to be made part of or attached to the submission by checking one or more boxes next to the desired document name.

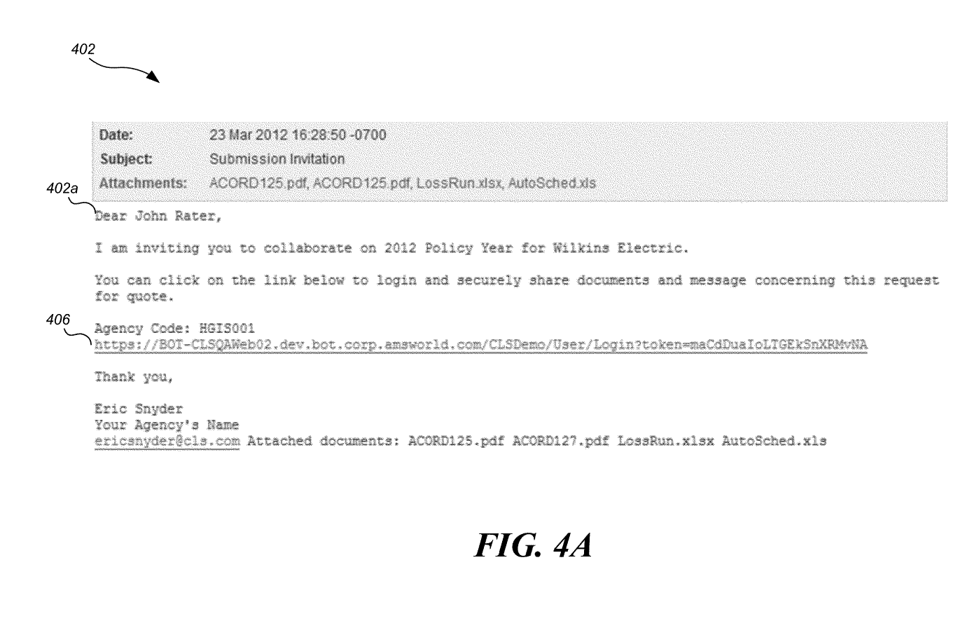

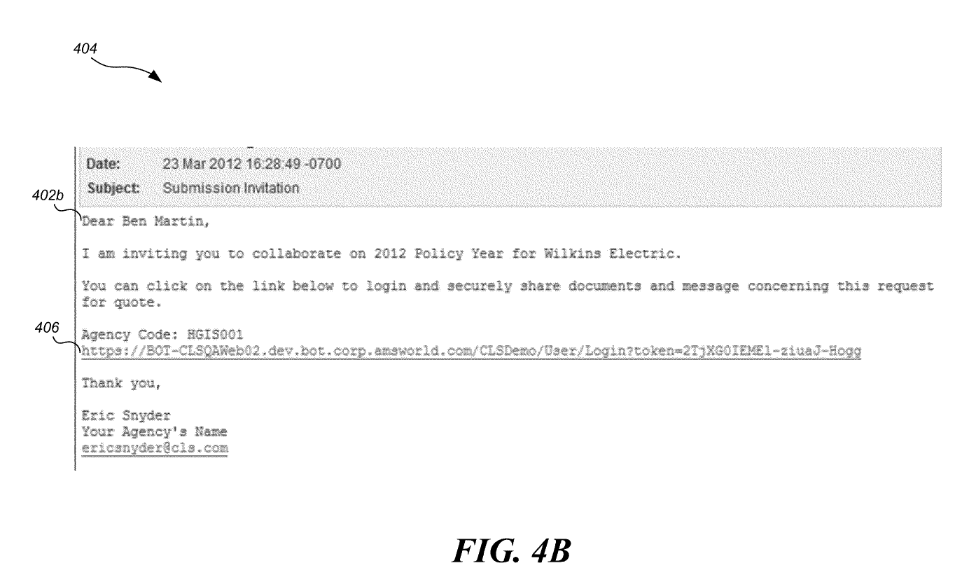

The message text entry field 317k allows the user to enter the text of the message to the selected insurers or underwriters to be included as part of the submission to invite the selected insurers or underwriters to respond and include any notes or details as appropriate regarding the submission. The salutation of the message may also be customized by the system for each individual recipient (including the names of selected individual representatives of the insurer or underwriter to whom the message will be sent). This may be accomplished in any number of ways, including, but not limited to, the system automatically or the user manually inserting code, variables, formulas or special fields to indicate the location in the message where the applicable name of the recipient will appear. An example of such a code 323 is shown in FIG. 3G within the text entry field 317k. Other portions of the message may be customized in a similar manner by including identifiable codes which will be replaced by the information applicable to the individual insurer, underwriter or representative in conjunction with sending the message. The system may rely on the database schema 700 in assessing the information to insert in the message that is applicable to the individual insurer, underwriter or representative, running appropriate queries against the information in the database. Examples of such customized messages are shown in FIGS. 4A and 4B.

FIGS. 4A and 4B are screen prints of first and second customized messages 402 and 404, each sent to a different one of a plurality of insurance companies by the agent or broker of an agency or brokerage. When the user selects the “invite” icon 317b, the same submission is automatically sent to all the selected insurers or underwriters according to each insurer's or underwriter's access type and other customizations. For example, the salutations of the messages are also customized to include the name of the insurer or underwriter, or the representative of the insurer or underwriter if selected. Note that in FIG. 4A, the first message 402 is shown with a customized message salutation “John Rater” 402a who represents one of the selected insurers to which the submission is sent, while the second message 404 is shown with a customized message salutation “Ben Martin” 402b who represents a different one of the selected insurers to which the submission is sent. Also provided in the first message 402 and second message 404 is a link 406 for the recipient to log on to the system to access the documents and collaborate accordingly. The link may also be customized to direct the recipient to the appropriate part, section or feature of the system. In other embodiments, the documents may be included as attachments to the messages.

FIG. 5A is a screen print of the portion 300 of the user interface of FIG. 3B particularly illustrating submissions sent to a plurality of insurance companies as part of a submission for a particular insured or client. The submissions panel 317a includes a submissions summary area 317l in which records of the submissions for the client and policy year selected within the active engagements subpanel 310 are listed. Each record includes a name field 317m, a status field 317n, a status reason field 317o, a due date filed 317q, a lines of business field 317t and an estimated premium field 317u. The name field 317m corresponds to the name of the submission as initially designated by the name of the insurer or underwriter to whom the submission is sent. This submission name may be subsequently renamed by the agent or other authorized user and the updated submission name will appear in the name field 317m. The status field 317n is an editable field which indicates a status of the message sent to the insurer or underwriter. For example, the status may indicate a status of the request sent in the submission. The status field 317n includes a selectable status list from which a status of the message sent to the underwriter may be selected to update the record. The status reason field 317o is an editable field which indicates a reason for the status of the message sent to the insurer or underwriter. For example, the status may indicate a reason for the current status identified in the status field 317n of the request sent in the submission. The status reason field 317n includes a selectable status reason list from which a reason for the status of the message sent to the underwriter may be selected to update the record.

The due date field 317q, lines of business field 317t and the estimated premium field 317u correspond to the due date, lines of business and estimated premium selected or entered by the agent using the create submission due date field 317d, lines of business menu 317g and create submission estimated premium field 319, respectively. The insurance company field 317s indicates the insurer or underwriter to which the submission was sent and the last modified field 317r indicates a date on which the submission was last modified by the agent who sent the submission or other authorized user. Although not all the fields in the portion 300 of the user interface are shown as editable, any combination of the fields may be editable in various embodiments.

FIG. 5B is a screen print of the first portion of the user interface 300 of FIG. 3A particularly illustrating a message 374 sent to a particular insurance company as part of a submission for a particular insured or client.

The content window 372 presents a set of electronic mail messages 374 (only one shown). Selection of a corresponding expand/collapse icon (i.e., [symbol] , ▾) toggles between presenting and hiding the content of the respective electronic mail message 374. As shown in FIG. 5B, the expand/collapse icon (i.e., [symbol] , ▾) is selected such that the content 311 of the message 374 is shown. The system displays the messages in the messages subpanel 354 specifically associated with the client selected in the active engagements subpanel 314. Also, the system displays the documents in the documents subpanel 352 specifically associated with the client selected in the active engagements subpanel 314.

A from field 376a indicates an identity of a sender of the particular electronic mail message. A title field 376b indicates a title of the electronic mail message or name of a project to which the electronic mail message is related. A date posted field 376c indicates a date that the electronic mail message was sent or otherwise posted. The fields 376a-376c are collectively referenced as 376.

A filter pull-down menu 378 allows filtering of electronic messages. Selection of a user selectable new message icon 380 opens a window that allows composition of a new electronic mail message, including entry of content, specification of intended recipient, title, and/or attachment of electronic documents or hyperlinks to electronic documents.

FIG. 6 is a screen print of the portion 300 of the user interface of FIG. 3A particularly illustrating a documents and messages panel 350 for an engagement with a particular insured or client as used by an insurance company to whom the message was sent. To an insurance company user (i.e., an insurer or underwriter user), the insurance management system displays in the active engagements panel 310 all the agencies that have sent the insurance company submissions using the insurance management system. The insurance management system also displays all the various customers/insureds that are associated with those submissions organized by agency in the active engagements panel 310. For example, as shown in FIG. 6, the insurance management system displays in the active engagements panel 310 all the various customers/insureds that are associated with submissions Chubb 321 to Ben Martin 306.

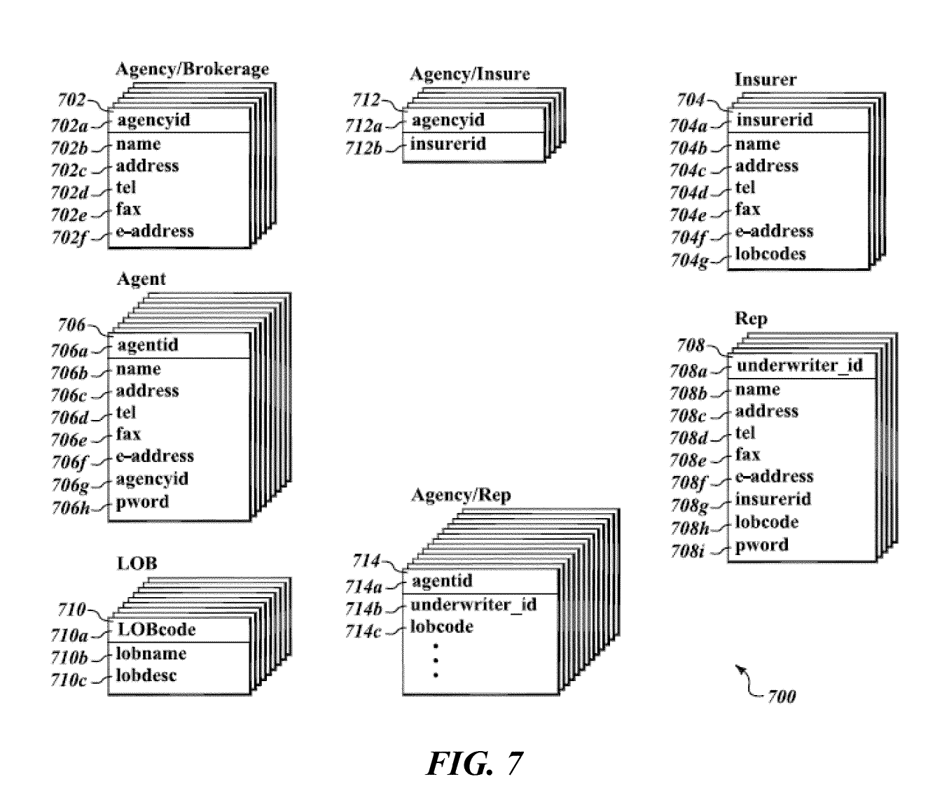

FIG. 7 shows a database schema 700 according to one illustrated embodiment. The illustrated database schema 700 may be suitable for use in an insurance management system to automate and/or manage communications between processor-based devices operated by agents or brokers of various agencies or brokerages and processor-based devices operated by underwriters of an insurer. Other database schemas may be suitable. The database schema 700 may be implemented in one or more computer- or processor-readable storage media, by operation of one or more processors that execute suitable instructions. The database schema 700 may include a number of data structures to store various pieces of information used in automating and managing the communications. The data structures may include a record, table or other data structure which includes information or data.

The database schema 700 may include a number of agency/brokerage records 702 that store information related to agencies. The agency/brokerage records 702 may include a number of fields, including an agency/brokerage_id field 702a, which is a key field on which a search may be performed. The agency/brokerage records 702 may include a name field 702b to store a name of the agency/brokerage, an address field 702c to store a physical or mailing address of the agency/brokerage, a tel field 702d to store a telephone number and fax field 702e to store a facsimile number for the agency/brokerage, and an e-address field 702f to store one or more electronic mail addresses for the agency/brokerage.

The database schema 700 may include a number of insurer records 704 that store information related to agencies. The insurer records 704 may include a number of fields, including an insurer_id field 704a, which is a key field on which a search may be performed. The insurer records 704 may include a name field 704b to store a name of the insurer, an address field 704c to store a physical or mailing address of the insurer, a tel field 704d to store a telephone number and fax field 704e to store a facsimile number for the insurer, and an e-address field 704f to store one or more electronic mail addresses for the insurer. The insurer records 704 may also include an LOB_Codes field 704g that stores codes of one or more lines of business handled by the insurer.

The database schema 700 may include a number of agent/broker records 706 that store information related to agencies. The agent/broker records 706 may include a number of fields, including an agent/broker_id field 706a, which is a key field on which a search may be performed. The agent/broker records 706 may include a name field 706b to store a name of the agent/broker, an address field 706c to store a physical or mailing address of the agent/broker, a tel field 706d to store a telephone number and fax field 706e to store a facsimile number for the agent/broker, and an e-address field 706f to store one or more electronic mail addresses for the agent/broker. The agent/broker records 706 may also include an agency_id field 706g that stores an identifier that uniquely identifies an agency or brokerage for which the agent/broker works. The identifier in the agency_id field 706g allows an agent or broker to be logically associated with an agency record 702. The agent/broker records 706 may also include a pword field 706g that stores a password, which allows attempts to access the system to be verified or authenticated. The password may be selected by the particular agent or broker.

The database schema 700 may include a number of underwriter records 708 that store information related to agencies. The underwriter records 708 may include a number of fields, including an underwriter_id field 708a, which is a key field on which a search may be performed. The underwriter records 708 may include a name field 708b to store a name of the underwriter, an address field 708c to store a physical or mailing address of the underwriter, a tel field 708d to store a telephone number and fax field 708e to store a facsimile number for the underwriter, and an e-address field 708f to store one or more electronic mail addresses for the underwriter. The underwriter records 708 may also include an insurer_id field 708g that stores an identifier that uniquely identifies an insurer for which the underwriter works. The identifier in the insurer_id field 708g allows an underwriter to be logically associated with an insurer record 704. The insurer records 704 may also include an LOB_Codes field 708h that stores codes of one or more lines of business handled by the underwriter. The underwriter records 708 may also include a sword field 708i that stores a password, which allows attempts to access the system to be verified or authenticated. The password may be selected by the particular agent or broker.

The database schema 700 may include a number of lines of business (LOB) records 710 that store information related to lines of business. The LOB records 710 may include a number of fields, including an LOB-Code field 710a, which is a key field on which a search may be performed. The LOB records 710 may include an LOB_name field 710b to store a name of a line of business and, optionally an LOB_desc field 710c to store a text description of the particular line of business.

The database schema 700 may include a number of agency/insurer records or table 712 that store information that relates agencies and/or brokerages to insurers. The agency/insurer records or table 712 may include a number of fields. For example, agency/insurer records or table 712 may include an agency/broker_id field 712a, which stores agency/broker identifiers which uniquely identify an agency or broker and which is a key field on which a search may be performed. The agency or broker identifiers allow logical relationships to be made to the agency/brokerage records 702. Also for example, agency/insurer records or table 712 may include an insurer_id field 712b, which stores insurer identifiers which uniquely identify an insurer and which may be a key field on which a search may be performed. The insurer identifiers allow logical relationships to be made to the insurer records 704.

The database schema 700 may include a number of agent/underwriter records or table 714 that store information that relates agents and/or brokers to underwriters of insurers. The agent/underwriter records or table 714 may include a number of fields. For example, agent/underwriter records or table 714 may include an agent/broker_id field 714a, which stores agency/broker identifiers which uniquely identify an agent or broker and which is a key field on which a search may be performed. The agency/broker identifiers may for example take the form of electronic mail addresses via which the respective agents or brokers receive electronic correspondence. Alternatively, the agency/broker identifiers may take the form of a numeric or alphanumeric identifier. The agent or broker identifiers allow logical relationships to be made to the agent/broker records 706. Also for example, agent/underwriter records or table 714 may include a rep_id field 714b, which stores underwriter identifiers which uniquely identify an underwriter of an insurer and which optionally may be a key field on which a search may be performed. The underwriter identifiers allow logical relationships to be made to the underwriter records 708. The underwriter identifiers may for example take the form of electronic mail addresses via which the respective underwriters receive electronic correspondence. Alternatively, the underwriter identifiers may take the form of a numeric or alphanumeric identifier. The agent/underwriter records or table 714 may further include an LOB_code field 714c. The LOB-code field 714c may store one or more LOB-codes which may specify specific lines of business that the agent or broker uses the respective insurer underwriter to handle. This may allow electronic correspondence, including sharing of electronic documents, to be targeted to specific underwriters based on the lines of business to which the correspondence and/or electronic documents relate.

The database schema 700 is illustrative. The database schema 700 may employ additional records or tables and/or may omit some records or tables. The illustrated records or tables may include additional fields, omit some of the illustrated fields, and/or may be arranged in forms other than illustrated.

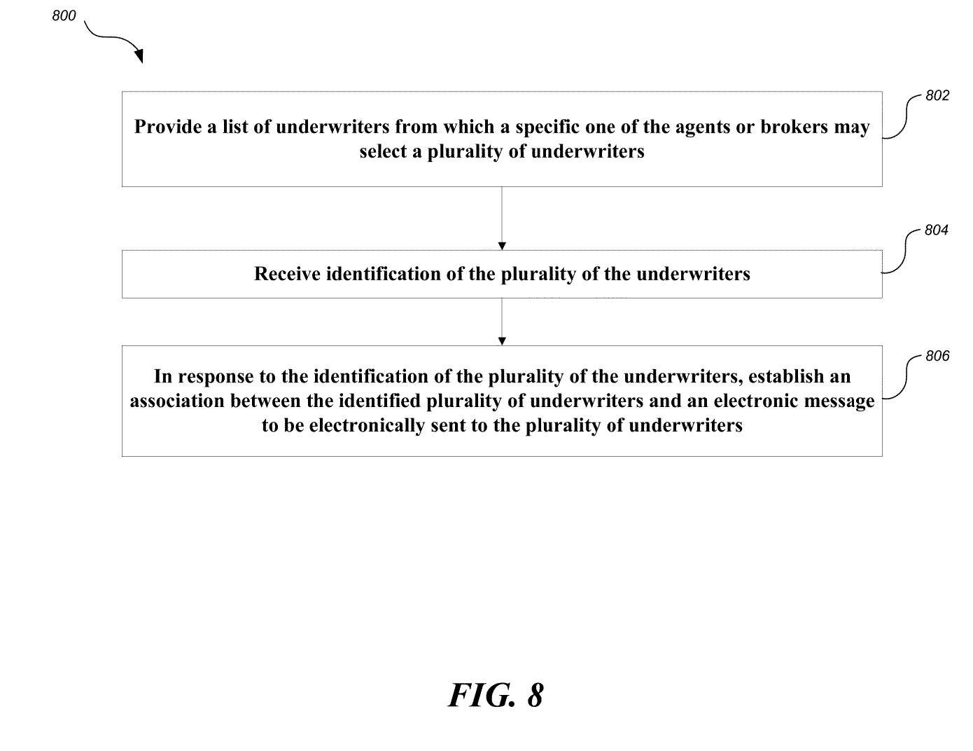

FIG. 8 shows a method 800 of operation of an insurance management system to automate and/or manage communications between one or more agents or brokers and one or more underwriters of a number of insurers by associating a plurality of underwriters with an electronic message, according to one illustrated embodiment.

At 802, an insurance management system server computer system provides a list of underwriters from which the specific one of the agents or brokers may select a plurality of underwriters. For example, an agency or brokerage may routinely transact business with two or more insurance carriers or insurers. All of these insurance carriers or insurers may be presented in a user selectable list, allowing an agent to easily view and select between those insurance carriers, underwriters or insurers. Each insurance carrier or insurer may be presented by name in a user selectable element (e.g., pull-down menu) or a user interface. At 804, the insurance management system server computer system receives identification of the plurality of the underwriters. For example, the insurance management system server computer system may receive an indications of selections from the provided list.

At 806, in response to the identification of the plurality of the underwriters, the insurance management system server computer system establishes an association between the identified plurality of underwriters and an electronic message to be electronically sent to the plurality of underwriters. The message to be electronically sent to the plurality of underwriters from the specific one of the agents or brokers may be regarding one or more existing or potential insurance policies for which the agent wants to invite quotes or bids on from the selected underwriters. For example, this association may be stored in the database 700, such that the database may be queried by the system for each of the underwriters' email addresses and the message may be sent to the plurality of underwriters.

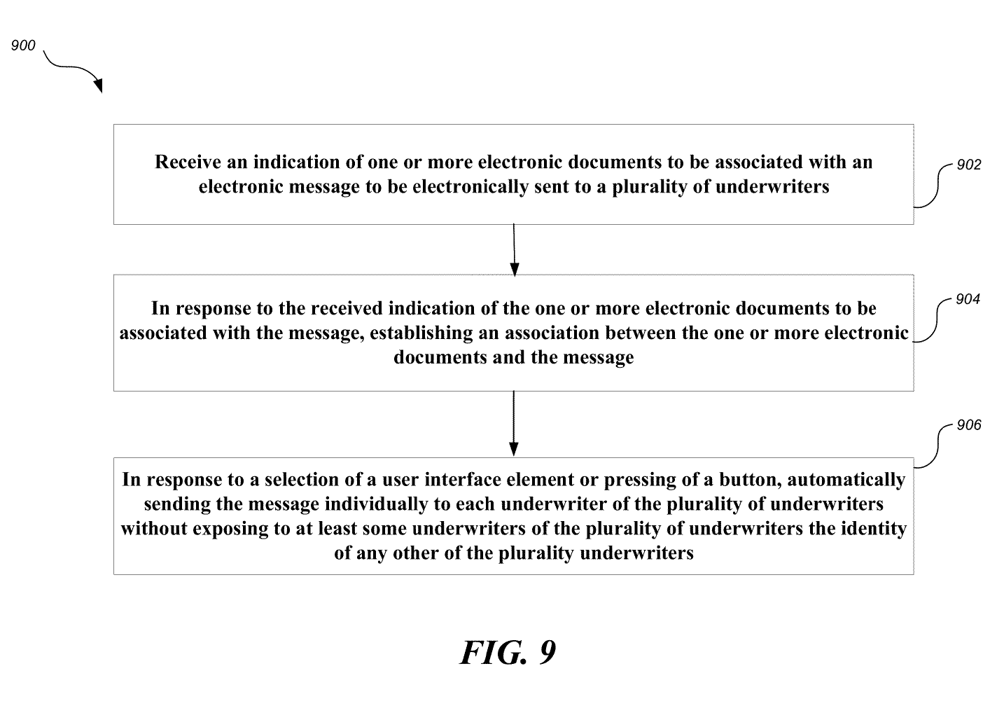

FIG. 9 shows a method 900 of operation of the insurance management system useful in the method of FIG. 8 by automatically sending the message to the associated plurality of underwriters, according to one illustrated embodiment.

At 902, an insurance management system server computer system receives an indication of one or more electronic documents to be associated with the electronic message to be electronically sent to a plurality of underwriters (e.g., the electronic message of FIG. 8).

At 904, the insurance management system server computer system, in response to the received indication of the one or more electronic documents to be associated with the message, establishes an association between the one or more electronic documents and the message.

At 906, the insurance management system server computer system, in response to a selection of a user interface element or pressing of a button, automatically sends the message individually to each underwriter of the plurality of underwriters without exposing to at least some underwriters of the plurality of underwriters the identity of any other of the plurality underwriters. In some embodiments, the insurance management system server computer system operates without exposing to any underwriter of the plurality of underwriters the identity of any other underwriter of the plurality underwriters.

The message provides at least one way for each insurer of the plurality of insurers to electronically access the associated one or more electronic documents. The at least one way for each insurer of the plurality of insurers to electronically access the associated one or more electronic documents may include, but is not limited to one or more of: an attachment of the one or more electronic documents to the message, a link in the message to the one or more electronic documents, a password or code to access the one or more electronic documents, a location of the one or more electronic documents, a link for the insurer to access the insurance management system; pushing of the one or more electronic documents to a system of the insurer, wherein the message is sent to the system of the insurer; pushing of the one or more electronic documents to a system of the insurer via Web services, wherein the message is a Web services message.

For example, the electronic documents may be automatically pushed from the insurance management system to an insurer's back office system based on a set of defined settings. Such may be accomplished via electronic mail with corresponding electronic documents attached, or via other techniques for instance using Web services.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification including, but not limited to: U.S. application Ser. No. ______ filed on the same date as this application in the names of Eric William Snyder, Lloyd Sutton Hawes II, and Hon Seng Long and entitled “APPARATUS, METHOD AND ARTICLE TO AUTOMATE AND MANAGE COMMUNICATIONS IN A NETWORKED ENVIRONMENT” (Atty. Docket No. 930140.409) and U.S. application Ser. No. ______ filed on the same date as this application in the names of Eric William Snyder, Steven Preston Finch, Hon Seng Long, and Lloyd Sutton Hawes II, and entitled “APPARATUS, METHOD AND ARTICLE TO AUTOMATE AND MANAGE ELECTRONIC DOCUMENTS IN A NETWORKED ENVIRONMENT” (Atty. Docket No. 930140.411) are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation in an insurance management system to automate communications between devices operated by a number of agents or brokers of each of a plurality of insurance agencies or brokerages and devices operated by a number of insurers of each of a plurality of insurance carriers, the insurance management system including at least one processor, at least one nontransitory computer-readable medium communicatively coupled to the at least one processor, and a plurality of communications ports to provide communications with the devices operated by the insurers and the agents or brokers, the method comprising:
in response to identification of a plurality of the insurers by a specific one of the agents or brokers, establishing a logical association between the identified plurality of insurers and an electronic message to be electronically sent to the plurality of insurers from the specific one of the agents or brokers regarding one or more existing or potential insurance policies, the logical association being established in the nontransitory computer-readable medium by the at least one processor;
receiving, by the insurance management system, an indication of one or more electronic documents to be associated with the message; and
in response to the received indication of the one or more electronic documents to be associated with the message, establishing a logical association between the one or more electronic documents and the message, the logical association being established in the nontransitory computer-readable medium by the at least one processor;
associating, by the insurance management system, a specific insured with each insurer of the plurality of insurers to which the message is to be sent, the logical association between the specific insured and each insurer of the plurality of insurers to which the message is to be sent being established in the nontransitory computer-readable medium by the at least one processor; and
in response to a selection of a user interface element or pressing of a button, automatically sending, by the insurance management system, the message individually to each insurer of the plurality of insurers, the message providing at least one way for each insurer of the plurality of insurers to electronically access the associated one or more electronic documents, and wherein the insurance management system operates without exposing to at least some insurers of the plurality of insurers the identity of any other of the plurality insurers.

2. The method of claim 1 wherein the insurance management system operates without exposing to any insurer of the plurality of insurers the identity of any other insurer of the plurality insurers.

3. The method of claim 1, further comprising:
providing, by the insurance management system, a list of insurers from which the specific one of the agents or brokers may select the plurality of insurers; and
receiving, by the insurance management system, the identification of the plurality of the insurers as a result of the selection of the plurality of insurers by the specific one of the agents or brokers.

4. The method of claim 3, further comprising:
providing, by the insurance management system, a list of one or more representatives of at least one of the plurality of insurers from which the specific one of the agents or brokers may select to individually receive the message; and
receiving, by the insurance management system, a selection of at least one of the one or more representatives, wherein the sending the message includes sending the message to the selected at least one of the one or more representatives.

5. The method of claim 4, further comprising:
receiving, by the insurance management system, an indication of one or more insurance lines of business associated with at least one of the one or more existing or potential insurance policies, and wherein the providing the list of one or more representatives is based on the received indication of the one or more insurance lines of business.

6. The method of claim 1, further comprising:
receiving, by the insurance management system, an indication of the specific insured, wherein the one or more existing or potential insurance policies is for the specific insured;
receiving, by the insurance management system, documents associated with the specific insured; and
associating, by the insurance management system, the specific insured with the message, the logical association between the specific insured and the message being established in the nontransitory computer-readable medium by the at least one processor.

7. The method of claim 6 wherein the receiving, by the insurance management system, an indication of one or more electronic documents to be associated with the message includes receiving an indication of one or more of the received documents associated with the specific insured.

8. The method of claim 6 further wherein the message includes a request for a quote from the plurality of the insurers to underwrite at least one of the one or more existing or potential insurance policies.

9. The method of claim 8, further comprising:
providing, by the insurance management system, for an agent or broker of the insurance agency or brokerage of the specific one of the agents or brokers, a list of insureds associated with the insurance agency or brokerage including the specific insured; and
in response to receiving and indication of selection of the specific insured from the list of insureds by the agent or broker of the insurance agency or brokerage of the specific one of the agents or brokers, providing, by the insurance management system, access to a selectable list of each insurer of the plurality of insurers to which the message was sent.

10. The method of claim 9, further comprising:
in response to receiving and indication of selection of one of the plurality of insurers from the list of each insurer of the plurality of insurers by the agent or broker of the insurance agency or brokerage of the specific one of the agents or brokers, providing, by the insurance management system: the message sent to the selected one of the plurality of insurers, an indication of the message sent to the selected one of the plurality of insurers being from the specific one of the agents or brokers and a selectable list of the associated one or more electronic documents.

11. The method of claim 9, further comprising:
in response to receiving the indication of selection of the specific insured from the list of insureds by the agent or broker of the insurance agency or brokerage of the specific one of the agents or brokers, providing, by the insurance management system:
for each insurer of the plurality of insurers to which the message was sent, access to a record which indicates one or more of: a name of the insurer, a status of the message sent to the insurer, a status of a request to the insurer included in the message sent to the insurer, a status reason for the status of the message sent to the insurer, a status reason for the request to the insurer included in the message sent to the insurer, a due date of the request to the insurer, an estimated premium associated with the one or more existing or potential insurance policies and an indication of one or more insurance lines of business associated with at least one of the one or more existing or potential insurance policies.

12. The method of claim 11 wherein the status of the message sent to the insurer, the status of the request to the insurer included in the message sent to the insurer, the status reason for the status of the message sent to the insurer and the status reason for the request to the insurer included in the message sent to the insurer are each editable by the agent or broker of the insurance agency or brokerage of the specific one of the agents or brokers.

13. The method of claim 1 wherein the automatically sending the message individually to each insurer of the plurality of insurers includes, for at least one of the insurers of the plurality of insurers, automatically inserting, by the insurance management system, a name of a representative of the at least one insurer in a salutation of the message.

14. The method of claim 1, further comprising:
providing, by the insurance management system, a message content input interface enabling the specific one of the agents or brokers to create content of the message to be electronically sent to the plurality of insurers; and
including, by the insurance management system, content created by the specific one of the agents or brokers via the message content input interface.

15. An insurance management system to automate communications between devices operated by a number of agents or brokers of each of a plurality of insurance agencies and devices operated by a number of insurers of each of a plurality of insurance carriers, the insurance management system comprising:
at least one processor;
at least one nontransitory computer-readable medium communicatively coupled to the at least one processor, and
a plurality of communications ports to provide communications with the devices operated by the insurers and the agents or brokers, wherein:
in response to identification of a plurality of the insurers by a specific one of the agents or brokers, the at least one processor establishes in the nontransitory computer-readable medium a logical association between the identified plurality of insurers and an electronic message to be electronically sent to the plurality of insurers from the specific one of the agents or brokers regarding one or more existing or potential insurance policies;
the insurance management system receives an indication of one or more electronic documents to be associated with the message;
in response to the received indication of the one or more electronic documents to be associated with the message, the at least one processor establishes in the nontransitory computer-readable medium a logical association between the one or more electronic documents and the message;
the at least one processor establishes in the nontransitory computer-readable medium a logical association between a specific insured and each insurer of the plurality of insurers to which the message is to be sent; and
in response to a selection of a user interface element or pressing of a button, the insurance management system automatically sends the message individually to each insurer of the plurality of insurers, the message providing at least one way for each insurer of the plurality of insurers to electronically access the associated one or more electronic documents, and wherein the insurance management system operates without exposing to at least some insurers of the plurality of insurers the identity of any other of the plurality insurers.

16. The insurance management system of claim 15 wherein the insurance management system operates without exposing to any insurer of the plurality of insurers the identity of any other insurer of the plurality insurers.

17. The insurance management system of claim 15 wherein the insurance management system:
provides a list of insurers from which the specific one of the agents or brokers may select the plurality of insurers; and
receives the identification of the plurality of the insurers as a result of the selection of the plurality of insurers by the specific one of the agents or brokers.

18. The insurance management system of claim 17 wherein the insurance management system:
provides a list of one or more representatives of at least one of the plurality of insurers from which the specific one of the agents or brokers may select to individually receive the message; and
receives a selection of at least one of the one or more representatives, wherein the sending the message includes sending the message to the selected at least one of the one or more representatives.

19. The insurance management system of claim 18, further comprising:
receiving, by the insurance management system, an indication of one or more insurance lines of business associated with at least one of the one or more existing or potential insurance policies, and wherein the providing the list of one or more representatives is based on the received indication of the one or more insurance lines of business.

20. The insurance management system of claim 15 wherein the insurance management system:
receives an indication of the specific insured, wherein the one or more existing or potential insurance policies is for the specific insured;
receives documents associated with the specific insured; and
associates, in the nontransitory computer-readable medium, the specific insured with the message.

21. The insurance management system of claim 20 wherein the insurance management system receives an indication of one or more electronic documents to be associated with the message based on an indication received of one or more of the received documents associated with the specific insured.

22. The insurance management system of claim 20 wherein the insurance management system:
customizes the message individually for at least some insurers of the plurality of insurers before the insurance management system automatically sends the message.

23. The insurance management system of claim 22 wherein the insurance management system:
provides, for an agent or broker of the insurance agency or brokerage of the specific one of the agents or brokers, a list of insureds associated with the insurance agency or brokerage including the specific insured; and
in response to receiving and indication of selection of the specific insured from the list of insureds by the agent or broker of the insurance agency or brokerage of the specific one of the agents or brokers, provides access to a selectable list of each insurer of the plurality of insurers to which the message was sent.

24. The insurance management system of claim 23 wherein the insurance management system:
in response to receiving and indication of selection of one of the plurality of insurers from the list of each insurer of the plurality of insurers by the agent or broker of the insurance agency or brokerage of the specific one of the agents or brokers, provides: the message sent to the selected one of the plurality of insurers, an indication of the message sent to the selected one of the plurality of insurers being from the specific one of the agents or brokers and a selectable list of the associated one or more electronic documents.

25. The insurance management system of claim 23 wherein the insurance management system:
in response to receiving the indication of selection of the specific insured from the list of insureds by the agent or broker of the insurance agency or brokerage of the specific one of the agents or brokers, provides:
for each insurer of the plurality of insurers to which the message was sent, access to a record which indicates one or more of: a name of the insurer, a status of the message sent to the insurer, a status of a request to the insurer included in the message sent to the insurer, a status reason for the status of the message sent to the insurer, a status reason for the request to the insurer included in the message sent to the insurer, a due date of the request to the insurer, an estimated premium associated with the one or more existing or potential insurance policies and an indication of one or more insurance lines of business associated with at least one of the one or more existing or potential insurance policies.

26. The insurance management system of claim 15 wherein the status of the message sent to the insurer, the status of the request to the insurer included in the message sent to the insurer, the status reason for the status of the message sent to the insurer and the status reason for the request to the insurer included in the message sent to the insurer are each editable by the agent or broker of the insurance agency or brokerage of the specific one of the agents or brokers.

27. The insurance management system of claim 15 wherein the insurance management system:
for at least one of the insurers of the plurality of insurers, automatically inserts a name of a representative of the at least one insurer in a salutation of the message before the insurance management system automatically sends the message individually to each insurer of the plurality of insurers.

28. The insurance management system of claim 15 wherein the message includes a request for a quote from the plurality of the insurers to underwrite at least one of the one or more existing or potential insurance policies.

29. The insurance management system of claim 15 wherein the at least one way for each insurer of the plurality of insurers to electronically access the associated one or more electronic documents includes one or more of: an attachment of the one or more electronic documents to the message, a link in the message to the one or more electronic documents, a password or code to access the one or more electronic documents, a location of the one or more electronic documents, a link for the insurer to access the insurance management system; pushing of the one or more electronic documents to a system of the insurer, wherein the message is sent to the system of the insurer; pushing of the one or more electronic documents to a system of the insurer via Web services, wherein the message is a Web services message.

30. The insurance management system of claim 15 wherein the insurance management system:
displays to a representative of at least one of the plurality of insurers after validation of an identity of the representative a list of each agent or broker from which one or more respective messages was received via the insurance management system regarding one or more existing or potential insurance policies; and
for each agent or broker in the displayed list, displays to the representative a list organized by agent or broker of each insured that is associated with the agent or broker and at least one of the one or more respective messages.
